(19) United States
(12) Patent Application Publication
(10) Pub. No.: US 2025/0341607 A1
(43) Pub. Date: Nov. 6, 2025

(54) RCS VARIANCE IN ISAC SYSTEMS

(71) Applicant: QUALCOMM Incorporated, San Diego, CA (US)

(72) Inventors: Min HUANG, Beijing (CN); Jing DAI, Beijing (CN); Danlu ZHANG, San Diego, CA (US); Chao WEI, Beijing (CN); Hao XU, Beijing (CN)

(21) Appl. No.: 18/871,147

(22) PCT Filed: Jul. 25, 2022
(86) PCT No.: PCT/CN2022/107588

§ 371 Date: Dec. 2, 2024

(51) Int. Cl. G01S 7/00; G01S 13/56; G01S 13/86; H04W 4/02

(52) U.S. Cl. CPC G01S 7/006; G01S 13/56; G01S 13/86; H04W 4/02

(57) ABSTRACT

Aspects presented herein relate to methods and devices for wireless communication including an apparatus, e.g., a UE or base station. The apparatus may transmit a configuration of at least one of a sensing threshold or a timer length for a timer associated with a sensing operation, wherein the configuration is transmitted to a second wireless device. The apparatus may also transmit a set of reference signals (RS) associated with the sensing operation, wherein the set of RS is transmitted for the second wireless device. Further, the apparatus may receive an indication of at least one of: (1) a fluctuation in a sensing reference signal received power (RSRP) for the sensing operation, or (2) at least one target object is outside of a monitoring area, wherein the indication is received from the second wireless device.

### TECHNICAL FIELD

The present disclosure relates generally to communication systems, and more particularly, to sensing operations in wireless communication systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine e communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be an apparatus for wireless communication at a first wireless device (e.g., a user equipment (UE) or a base station). The apparatus may transmit a configuration of at least one of a sensing threshold or a timer length for a timer associated with a sensing operation, where the configuration is transmitted to a second wireless device. The apparatus may also transmit a set of reference signals (RS) associated with the sensing operation, where the set of RS is transmitted for the second wireless device. Also, the apparatus may receive an indication of at least one of: (1) a fluctuation in a sensing reference signal received power (RSRP) for the sensing operation, or (2) at least one target object is outside of a monitoring area, where the indication is received from the second wireless device.

In an aspect of the disclosure, a method, a computer-readable medium, and an apparatus are provided. The apparatus may be an apparatus for wireless communication at a second wireless device (e.g., a UE or a base station). The apparatus may receive a configuration of at least one of a sensing threshold or a timer length for a timer associated with a sensing operation, where the configuration is received from a first wireless device. The apparatus may also receive a set of sensing RS associated with the sensing operation prior to an initiation of a timer associated with the sensing operation, where the set of sensing RS is received from the first wireless device. Further, the apparatus may detect that at least one of: (1) a sensing reference signal received power (RSRP) for the sensing operation is less than the sensing threshold, or (2) at least one target object is outside of a monitoring area. The apparatus may also monitor a set of sensing reference signals (RS) upon an initiation of the timer associated with the sensing operation, where the timer is initiated for the timer length. The apparatus may also detect that at least one of: (1) the sensing RSRP is greater than or equal to the sensing threshold prior to an expiration of the timer length, or (2) the at least one target object is within the monitoring area prior to the expiration of the timer length; and stop the timer. Moreover, the apparatus may detect that the sensing RSRP remains less than the sensing threshold until after an expiration of the timer length; and stop monitoring the set of sensing RS. The apparatus may also transmit an indication of at least one of: (1) a fluctuation in the sensing RSRP for the sensing operation, or (2) the at least one target object is outside of the monitoring area, where the indication is transmitted to the first wireless device.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of a wireless communication system.

FIG. 6A is a diagram illustrating an example of a wireless communication system utilizing monostatic sensing.

FIG. 6B is a diagram illustrating an example of a wireless communication system utilizing bi-static sensing or multi-static sensing.

FIG. 7 is a diagram illustrating an example of a wireless communication system utilizing bi-static sensing.

FIG. 8 is a diagram illustrating an example of a wireless communication system utilizing a handover.

FIG. 9 is a communication flow diagram illustrating example communications between a first wireless device and a second wireless device.

FIG. 10 is a graph illustrating an example timing for a sensing operation.

FIG. 11 is a graph illustrating an example timing for a sensing operation.

FIG. 12 is a communication flow diagram illustrating example communications between a first wireless device and a second wireless device.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a diagram illustrating an example of a hardware implementation for an example apparatus and/or network entity.

FIG. 18 is a diagram illustrating an example of a hardware implementation for an example network entity.

### DETAILED DESCRIPTION

Some aspects of wireless communication may utilize certain calculations or measurements for locating a position of an object, such as a radar cross section (RCS). The RCS of an object is the area intercepting that amount of power which, when scattered isotropically, produces a return at the radar equal to that from the target. That is, the RCS is the projected area of a sphere that has the same radar return as the target. RCS calculations may produce a number of issues, such as an incorrect trigger of a sensing reference signal (RS) resource release due to RCS variance. In some aspects, the RCS of a target object may change with different incident angles and/or reflected angles. That is, when an unmanned aerial vehicle (UAV) rotates, the received signal at a certain base station (BS) or UE may fluctuate. The micro-Doppler profile may also change with different incident and/or reflected angles, which may assist the detection of UAV rotation. In order to obtain a high-resolution ranging result, the sensing RS may have a large bandwidth, which may cost a large amount of radio resources. Therefore, to improve radio resource efficiency in an ISAC system, the radio resource of a sensing RS may be dynamically used by/assigned to the BS/UE. If the target object (e.g., UAV) moves away or disappears (e.g., lands on the ground), the radio resource for the sensing RS may be released. Further, when a UAV rotates, the BS/UE may determine that the UAV moves away or disappears (i.e., moves outside of a target area) based on an instant low received signal strength, and thus release its radio resource of sensing RS. This type of approach may suffer from certain issues, such as a false alarm. Also, if the UAV rotates quickly, applying/releasing radio resource of sensing RS may not keep up with the pace of a received sensing RS strength change. Additionally, aspects of wireless communication may experience handover issues (e.g., ping pong handover) due to RCS variance. Further, aspects of wireless communication may experience issues when using traditional communication handover methods. Aspects of the present disclosure may reduce the amount of incorrect triggering of a sensing RS resource release due to RCS variance. In some instances, aspects presented herein may reduce the amount of ping-pong handover due to RCS variance. Aspects of the present disclosure may also allow the use of traditional communication handover methods when experiencing RCS variance. For instance, aspects of the present disclosure may optimize the ability to perform sensing operations with RCS variance. Further, aspects presented herein may allow for efficient sensing operations for target objects including RCS variance.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units

(CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

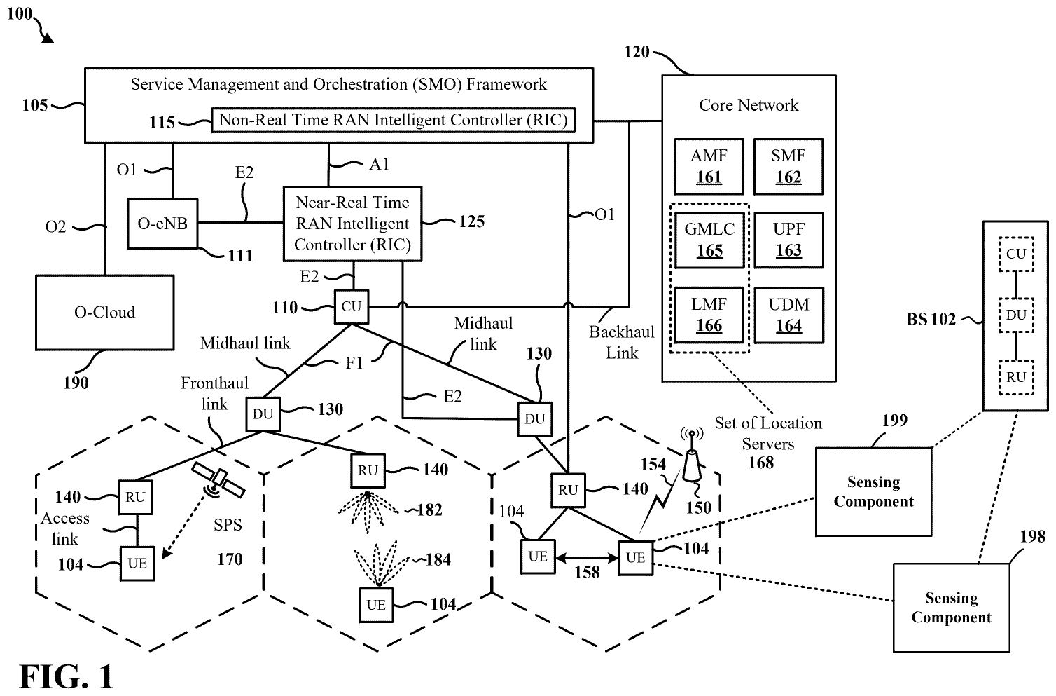

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 or the base station 102 may include a sensing component 198 that may be configured to transmit a configuration of at least one of a sensing threshold or a timer length for a timer associated with a sensing operation, where the configuration is transmitted to a second wireless device. Sensing component 198 may also be configured to transmit a set of reference signals (RS) associated with the sensing operation, where the set of RS is transmitted for the second wireless device. Sensing component 198 may also be configured to receive an indication of at least one of: (1) a fluctuation in a sensing reference signal received power (RSRP) for the sensing operation, or (2) at least one target object is outside of a monitoring area, where the indication is received from the second wireless device.

In certain aspects, the UE 104 or the base station 102 may include a sensing component 199 that may be configured to receive a configuration of at least one of a sensing threshold or a timer length for a timer associated with a sensing operation, where the configuration is received from a first wireless device. Sensing component 199 may also be configured to receive a set of sensing RS associated with the sensing operation prior to an initiation of a timer associated with the sensing operation, where the set of sensing RS is received from the first wireless device. Sensing component 199 may also be configured to detect that at least one of: (1) a sensing reference signal received power (RSRP) for the sensing operation is less than the sensing threshold, or (2) at least one target object is outside of a monitoring area. Sensing component 199 may also be configured to monitor a set of sensing reference signals (RS) upon an initiation of the timer associated with the sensing operation, where the timer is initiated for the timer length. Sensing component 199 may also be configured to detect that at least one of: (1) the sensing RSRP is greater than or equal to the sensing threshold prior to an expiration of the timer length, or (2) the at least one target object is within the monitoring area prior to the expiration of the timer length; and stop the timer. Sensing component 199 may also be configured to detect that the sensing RSRP remains less than the sensing threshold until after an expiration of the timer length; and stop monitoring the set of sensing RS. Sensing component 199 may also be configured to transmit an indication of at least one of: (1) a fluctuation in the sensing RSRP for the sensing operation, or (2) the at least one target object is outside of the monitoring area, where the indication is transmitted to the first wireless device. Although the following description may be focused on 5G NR, the concepts described herein may be applicable to other similar areas, such as LTE, LTE-A, CDMA, GSM, and other wireless technologies.

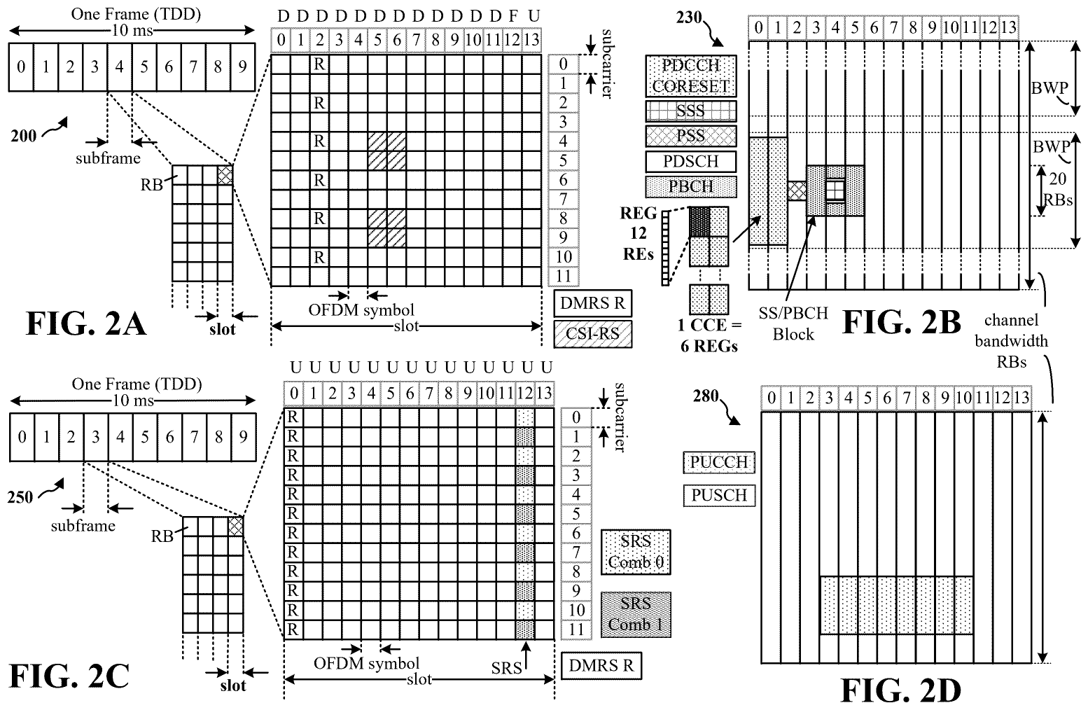

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

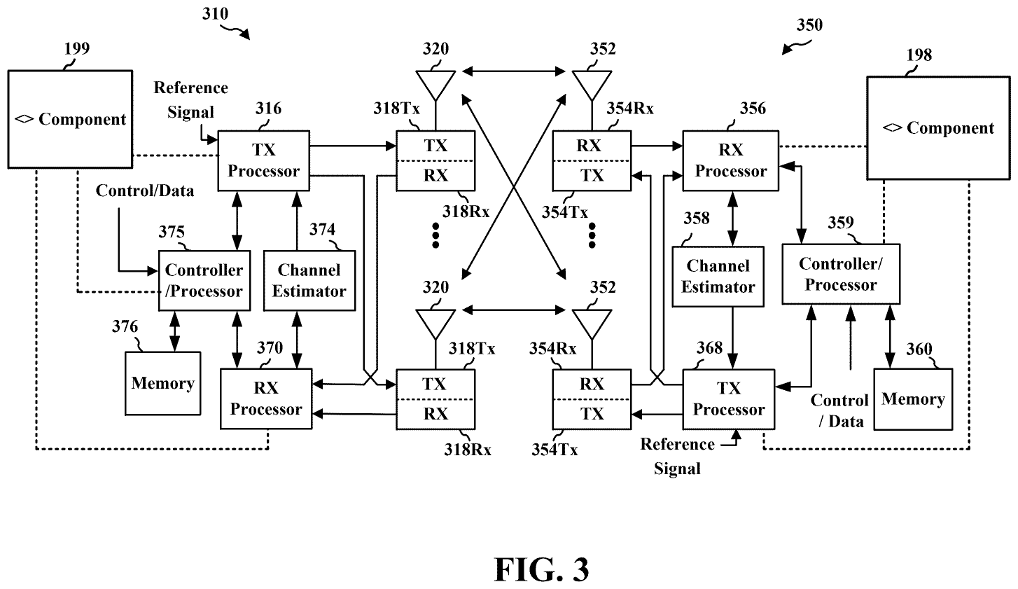

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the sensing component 198 of FIG. 1. At least one of the TX processor 316, the RX processor 370, and the controller/processor 375 may be configured to perform aspects in connection with the sensing component 199 of FIG. 1.

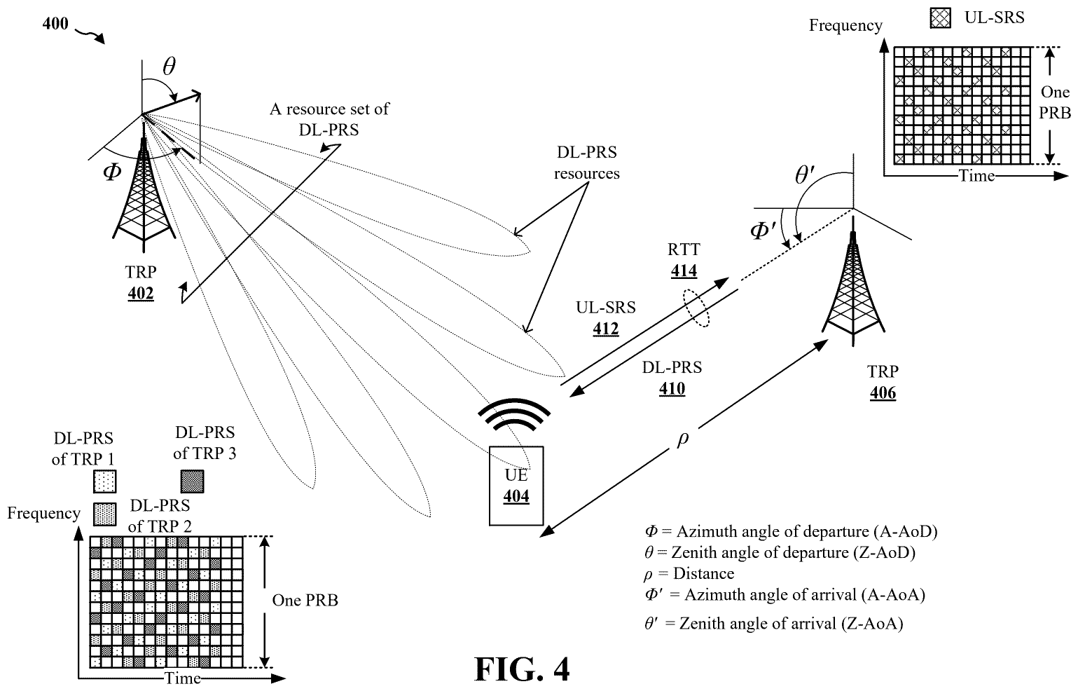

FIG. 4 is a diagram 400 illustrating an example of a UE positioning based on reference signal measurements. The UE 404 may transmit UL-SRS 412 at time TRS_TX and receive DL positioning reference signals (PRS) (DL-PRS) 410 at time TPRS RX. The TRP 406 may receive the UL-SRS 412 at time TSRS RX and transmit the DL-PRS 410 at time TPRS TX. The UE 404 may receive the DL-PRS 410 before transmitting the

UL-SRS 412, or may transmit the UL-SRS 412 before receiving the DL-PRS 410. In both cases, a positioning server (e.g., location server(s) 168) or the UE 404 may determine the RTT 414 based on |TSRS_RX-TPRS_TX|-|TSRS_TX-TPRS_RX. Accordingly, multi-RTT positioning may make use of the UE Rx-Tx time difference measurements (i.e., |TSRS_TX-TPRS_RX|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |TSRS_RX-TPRS_TX|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Aspects of wireless communication may utilize a number of different types of communication, such as integrated sensing and communication (ISAC). ISAC refers to a combination of sensing and communication systems in order to utilize wireless resources efficiently and/or utilize wide area environment sensing. ISAC has resulted in a number of technological advances in signal processing and wireless communication. For instance, the combined use of millimeter wave (mmW) frequencies and massive multiple-input multiple-out (MIMO) technology may result in similarities between communication and radio sensing systems, e.g., similarities in hardware architecture, channel characteristics, and information processing pipeline. Accordingly, it may be possible to extend several radar missions (e.g., angle-of-arrival (AoA) or angle-of-departure (AoD) estimation and moving target tracking) in order to address different communication challenges, such as beam management and resource allocation. Further, certain types of wireless networks (e.g., ultra-dense and cell-free wireless networks) may enable a comprehensive characterization of the propagation environment for ISAC.

ISAC is regarded as one of the key features and technological advancements of certain types of wireless communication (e.g., 5G and 6G). Also, there are several different motivations for the use of ISAC, such as cost effectiveness and spectrum effectiveness. For cost effectiveness, aspects of ISAC may utilize a shared radio frequency (RF) and/or baseband hardware for sensing and communication. For spectrum effectiveness, aspects of ISAC may utilize an always-on availability of spectrum for different types of functions. Additionally, ISAC may utilize a number of different use cases, such as macro-sensing and micro-sensing. For macro-sensing use cases, aspects of ISAC may utilize meteorological monitoring, autonomous driving, dynamic map, low-altitude airspace management (e.g., with unmanned aerial vehicles (UAVs)), intruder detection, etc. For micro-sensing use cases, aspects of ISAC may utilize gesture recognition, vital signal detection, high-resolution imaging, etc. Also, aspects of ISAC may utilize sensing-assisted communication, e.g., beam management.

Some aspects of wireless communication may utilize object sensing. Certain types of object sensing may utilize radar sensing, which may be specified as monostatic sensing and bi-static/multi-static sensing. For example, object sensing or radar sensing may be utilized when sensing certain types of objects (e.g., unmanned aerial vehicles (UAVs)). Although UAVs may be referred to as objects that are sensed herein, other types of objects may also be sensed (e.g., vehicles, ships, machines, wireless devices, humans, animals, etc.). As such, when a UAV is referred to as being sensed herein, other types of objects may be the object that is being sensed (e.g., vehicles, ships, machines, wireless devices, humans, animals, etc.). In object or radar sensing, because of the irregular shape of target objects, reflected signals may be unevenly distributed in all directions. In order to increase the possibility of receiving the reflected sensing signal, some types of UEs (e.g., legacy UEs or sensing-dedicated UEs) may be involved in receiving the reflected signals. This type of object sensing is referred to as UE-assisted sensing, where the UE is referred to as a “sensing UE.” This type of object sensing may be utilized because the quantity of base stations (e.g., gNBs) in the cellular network is smaller than the quantity of UEs. This type of object sensing may also be utilized to sense of other kinds of objects (e.g., planes, vehicles, ships, humans, animals, or any object).

As indicated above, cellular networks can be used for UAV management (i.e., managing UAVs or other wireless objects). There are a number of expected benefits of UAV management by cellular networks, such as a lowered deployment cost for existing physical sites for sensing. Additionally, UAV management by cellular networks may result in a reduced hardware cost for shared RF/baseband hardware with a base station (BS). Some types of UAV management may utilize wide area airspace management, which may fit for cooperative sensing and target tracking in wireless systems (e.g., a 5G/6G system).

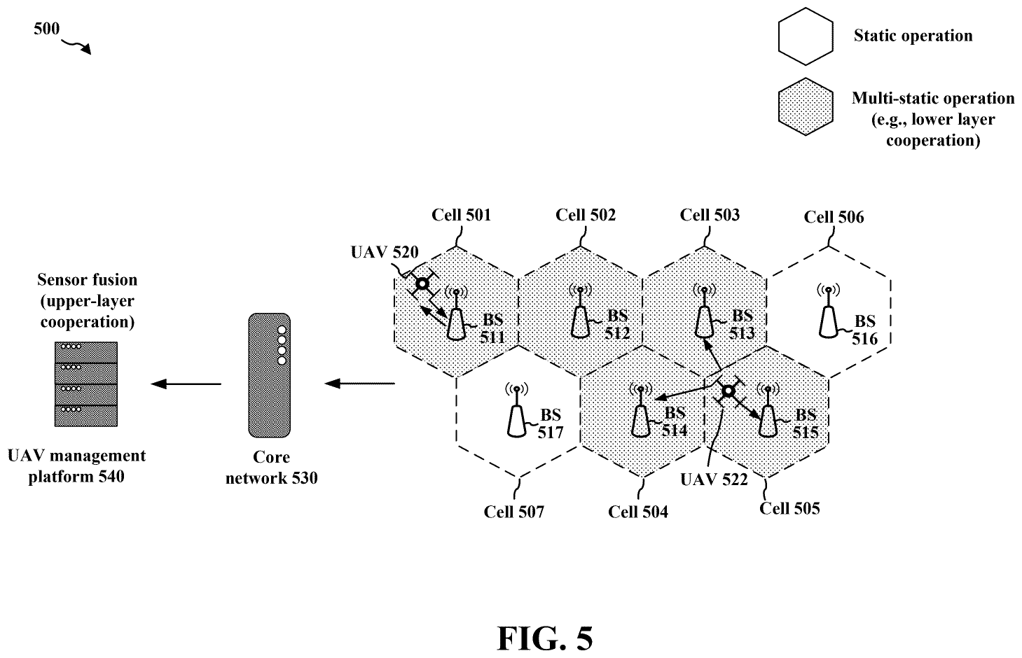

FIG. 5 illustrates diagram 500 including one example of a wireless communication system. More specifically, diagram 500 in FIG. 5 shows an example of wireless communication systems for cooperative sensing and target tracking. As shown in FIG. 5, diagram 500 includes a number of cells (cell 501, cell 502, cell 503, cell 504, cell 505, cell 506, cell 507) and a number of corresponding base stations (base station 511, base station 512, base station 513, base station 514, base station 515, base station 516, base station 517). Diagram 500 also includes UAV 520 and UAV 522, as well as core network 530 and UAV management platform 540. As shown in FIG. 5, cells 501-505 and base stations 511-515 are part of a multi-static operation (i.e., there is lower layer cooperation during the communication between the base stations). Cells 506-507 and base stations 506-507 are in a static operation (i.e., there is no lower layer cooperation between the base stations).

As indicated herein, aspects of object sensing may include monostatic sensing and bi-static/multi-static sensing. In monostatic sensing, one radar/sensor both transmits and receives the sensing signal. Monostatic sensing is advantageous as there may no need to form a transmit (Tx)/receive (Rx) (Tx/Rx) pairing or grouping. However, there may be a need to mitigate self-interference when utilizing monostatic sensing. In bi-static sensing or multi-static sensing, one radar/sensor transmits the sensing signal, and another radar/sensor receives the sensing signal that is reflected by a target object (e.g., a UAV). While bi-static/multi-static sensing may not need to mitigate self-interference, there may be a need to form a Tx/Rx pairing/grouping.

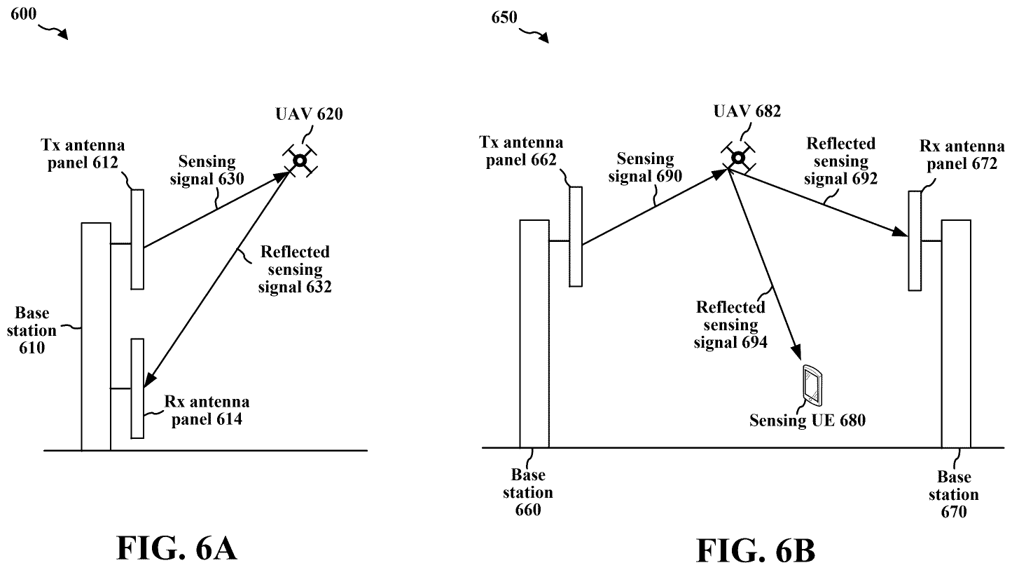

FIG. 6A and FIG. 6B illustrates diagram 600 and diagram 650, respectively, including examples of a wireless communication system utilizing monostatic sensing and bi-static/multi-static sensing. More specifically, diagram 600 in FIG. 6A shows an example of a wireless communication system utilizing monostatic sensing. As shown in FIG. 6A, diagram 600 includes base station 610 including Tx antenna panel 612 and Rx antenna panel 614, as well as UAV 620. Diagram 600 shows that sensing signal 630 is transmitted from Tx antenna panel 612 to UAV 620, and reflected sensing signal 632 is reflected from UAV 620 back to Rx antenna panel 614. Diagram 650 in FIG. 6B shows another example of wireless communication systems utilizing bi-static sensing or multi-static sensing. As shown in FIG. 6B, diagram 650 includes base station 660 including Tx antenna panel 662 and base station 670 including Rx antenna panel 672. FIG. 6B also includes sensing UE 680 and UAV 682. Diagram 650 shows that sensing signal 690 is transmitted from Tx antenna panel 662 to UAV 682. Also, reflected sensing signal 692 is forwarded from UAV 682 to Rx antenna panel 672, while reflected sensing signal 694 is forwarded from UAV 682 to sensing UE 680.

Some aspects of wireless communication may utilize different types of sensing operations. For example, aspects of wireless communications may utilize a monostatic sensing operation, a bi-static (or bistatic) sensing operation, or a multi-static sensing operation. Additionally, aspects of wireless communication may utilize UE-assisted sensing, such as when a UE assists with the sensing operation. In a UE-assisted sensing operation, the position of a sensing-UE may be known by a network or base station. For instance, the position of a sensing-UE may be based on certain positioning methods, such as global position system (GPS) or other UE positioning methods (e.g., round trip time (RTT), time difference of arrival (TDOA), etc.). In UE-assisted sensing operations, for some types of UEs (e.g., mobile phones or vehicles), there may be a high amount of the UEs, where the position of the UEs is flexible and the antenna gain of the UEs is low. For other types of UEs (e.g., a sensing-dedicated UE or a sensing road-side unit (RSU)), there may be a low amount of the UEs, where the position of the UEs is fixed and the antenna gain of the UEs is high.

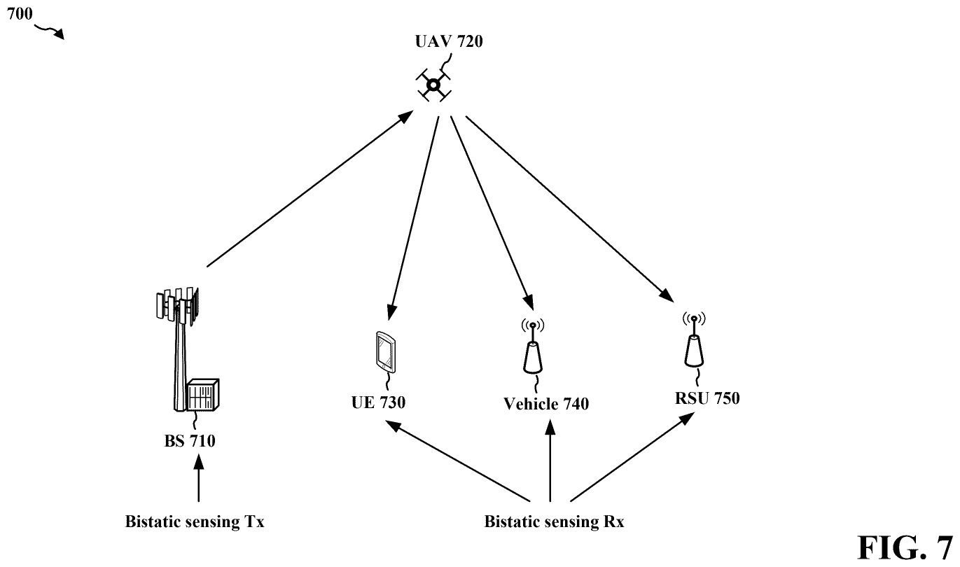

FIG. 7 illustrates diagram 700 including an example of a wireless communication system. More specifically, diagram 700 in FIG. 7 shows an example of a wireless communication system utilizing a bi-static (or bistatic) sensing procedure. As shown in FIG. 7, diagram 700 includes base station 710, UAV 720, UE 730, vehicle 740, and RSU 750. For instance, diagram 700 shows a UE-assisted sensing operation for a bi-static sensing transmitter (Tx) (e.g., base station 710) and a bi-static sensing receiver (Rx) (e.g., UE 730, vehicle 740, and/or RSU 750) for UAV 720. As depicted in FIG. 7, the sensing Rx (e.g., UE 730, vehicle 740, and/or RSU 750) may be based on certain positioning methods, such as GPS or other UE positioning methods (e.g., RTT, TDOA, etc.). Also, for some types of UEs (e.g., UE 730 or vehicle 740), there may be a high amount of the UEs, where the position of the UEs is flexible and the antenna gain of the UEs is low. For other types of UEs (e.g., RSU 750), there may be a low amount of the UEs, where the position of the UEs is fixed and the antenna gain of the UEs is high.

Some aspects of wireless communication may utilize certain calculations or measurements for locating a position of an object, such as a radar cross section (RCS). The RCS of an object is the area intercepting that amount of power which, when scattered isotropically, produces a return at the radar equal to that from the target. That is, the RCS is the projected area of a sphere that has the same radar return as the target. The unit of measurement for an object's RCS is decibels per square meter (dBsm). The power received by a radar for a target may indicate how well the radar can detect or track the target. RCS may be compared to different measurements, such as angles, where there may be a large RCS variation with various angles. In some instances, the RCS may be at a maximum when a sensing direction is perpendicular to the UAV plane. Also, the RCS may be at a minimum when a sensing direction is in the UAV plane. Compared to frequency, the RCS may fade more intensely at a few carrier frequencies.

RCS calculations may produce a number of issues, such as an incorrect trigger of a sensing reference signal (RS) resource release due to RCS variance. In some aspects, the RCS of a target object may change with different incident angles and/or reflected angles. That is, when a UAV rotates, the received signal at a certain base station (BS) or UE may fluctuate. The micro-Doppler profile may also change with different incident and/or reflected angles, which may assist the detection of UAV rotation. Additionally, in some aspects, there may be a dynamic radio resource allocation for sensing RS. The BS/UE may first use small bandwidth (BW) beam sweeping to discover/detect a target (e.g., at low carrier frequency or large wavelength), and then use wide BW sensing RS to estimate the position/speed of a target, as well as identify the type of target (e.g., at a high carrier frequency or small wavelength). In order to obtain a high-resolution ranging result, the sensing RS may have a large bandwidth, which may cost a large amount of radio resources. Therefore, to improve radio resource efficiency in an ISAC system, the radio resource of a sensing RS may be dynamically used by/assigned to the BS/UE. If the target object (e.g., UAV) moves away or disappears (e.g., lands on the ground), the radio resource for the sensing RS may be released. Further, when a UAV rotates, the BS/UE may determine that the UAV moves away or disappears (i.e., moves outside of a target area) based on an instant low received signal strength, and thus release its radio resource of sensing RS. This type of approach may suffer from certain issues, such as a false alarm. Also, if the UAV rotates quickly, applying/releasing radio resource of sensing RS may not keep up with the pace of a received sensing RS strength change.

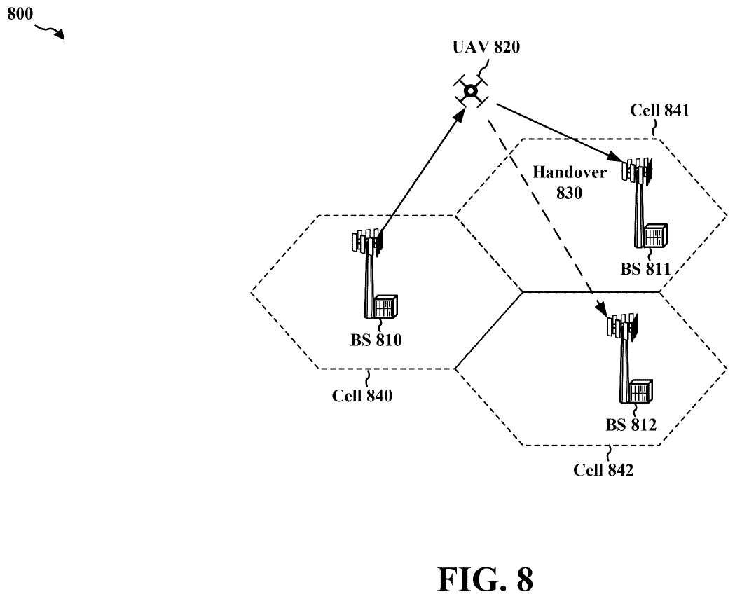

Additionally, aspects of wireless communication may experience handover issues (e.g., ping pong handover) due to RCS variance. FIG. 8 illustrates diagram 800 including an example of a wireless communication system. More specifically, diagram 800 in FIG. 8 shows an example of a wireless communication system experiencing handover issues. As shown in FIG. 8, diagram 800 includes base station 810, base station 811, base station 812, UAV 820, handover 830 (e.g., a ping pong handover), cell 840, cell 841, and cell 842. As depicted in FIG. 8, in bi-static sensing, UAV 820 may have a variant RCS and stay in a cell (e.g., cell 841) covered by a certain base station (e.g., base station 811). When the UAV 820 rotates, the sensing RSRP at base station 811 may be lower than a given threshold at certain rotation angles, and then the sensing RS resource release and handover (e.g., handover 830) to another base station (e.g., base station 812) may be incorrectly triggered. Due to RCS changing with each angle, when UAV 820 rotates, the received signal at the BS/UE may fluctuate. Measurements based on the sensing RSRP may lead to ping pong handover (i.e., frequent handover within a short period) if the UAV 820 rotates quickly. If the original base station (e.g., base station 811) releases the sensing signal resource and there is no other proper base station to sense, the sensing of the UAV 820 may be lost and may need to be restarted when the sensing RSRP is retrieved. This may lead to a long detection/tracking latency and a waste of radio resources.

Further, aspects of wireless communication may experience issues when using traditional communication handover methods. In some types of handover processes (e.g., an LTE/NR communication handover process), a UE may measure the reference signal of a source cell and a target cell, and then use a filter (e.g., a layer 3 (L3) filter) to determine the RSRP value. However, L3 filters may solely fit to slow channel status variance. For example, y(n)=αy(n−1)+(1−α)x(n), where a is close to 1 (e.g., α=0.9). Before and after a communication handover, the RSRP change may not be larger than 10 dB (e.g., the handover trigger may correspond to a 3 dB RSRP difference). In some instances, the RCS variance due to the UAV rotation may cause a fast channel status variance, so the traditional L3 filter method may not be used. Also, the RCS may vary from one value to another value (e.g., vary from −10 dBsm to −50 dBsm) when the UAV rotates a certain amount (e.g., ¼ circle) with a certain time period (e.g., less than 1 second). Based on the above, it may be beneficial to reduce the amount of incorrect triggering of a sensing RS resource release due to RCS variance. Further, it may be beneficial to reduce the amount of ping-pong handover due to RCS variance. Also, it may be beneficial to allow the use of traditional communication handover methods when handling RCS variance.

Aspects of the present disclosure may reduce the amount of incorrect triggering of a sensing RS resource release due to RCS variance. In some instances, aspects presented herein may reduce the amount of ping-pong handover due to RCS variance. Aspects of the present disclosure may also allow the use of traditional communication handover methods when experiencing RCS variance. For instance, aspects of the present disclosure may optimize the ability to perform sensing operations with RCS variance. Further, aspects presented herein may allow for efficient sensing operations for target objects including RCS variance.

In some instances, aspects presented herein may utilize timer-based methods, operations, and messages for sensing operations. In bistatic sensing, the Tx BS (or the sensing control node) may send a message to an Rx BS or Rx UE to configure a threshold (e.g., a threshold of G) and a timer length (e.g., a timer length of T). After detecting the sensing RSRP is less than a certain threshold (e.g., a threshold of G) or the target UAV disappears (i.e., the target UAV moves outside of a monitoring area), the Rx BS/UE may start a timer with a configured length (e.g., a length of T). While the timer runs, the Rx BS/UE may continue to monitor sensing RS. In one aspect, if the detected sensing RSRP is greater than or equal to a threshold (e.g., sensing RSRP ≥G) or the target UAV reappears in the monitoring area before the timer expires (i.e., prior to a timer length T expiring), the Rx BS/UE may stop the timer (e.g., this may occur when the UAV rotates quickly). After this occurs, the Rx BS/UE may send a message that indicates a sensing RSRP fluctuation or change. This message may contain the sensing RSRP fluctuation amplitude and/or period. This message may also help the Tx BS to recognize the UAV and estimate its rotation speed. In another aspect, if the detected sensing RSRP is less than a threshold (e.g., sensing RSRP<G) until the timer expires, the Rx BS/UE may stop monitor the sensing RS (e.g., this may occur when the UAV rotates slowly). After this occurs, the Rx BS/UE may send a message that indicates the target object is leaving (or has left) a monitoring area. Then, the Tx BS may stop transmitting the sensing RS to the Rx BS/UE.

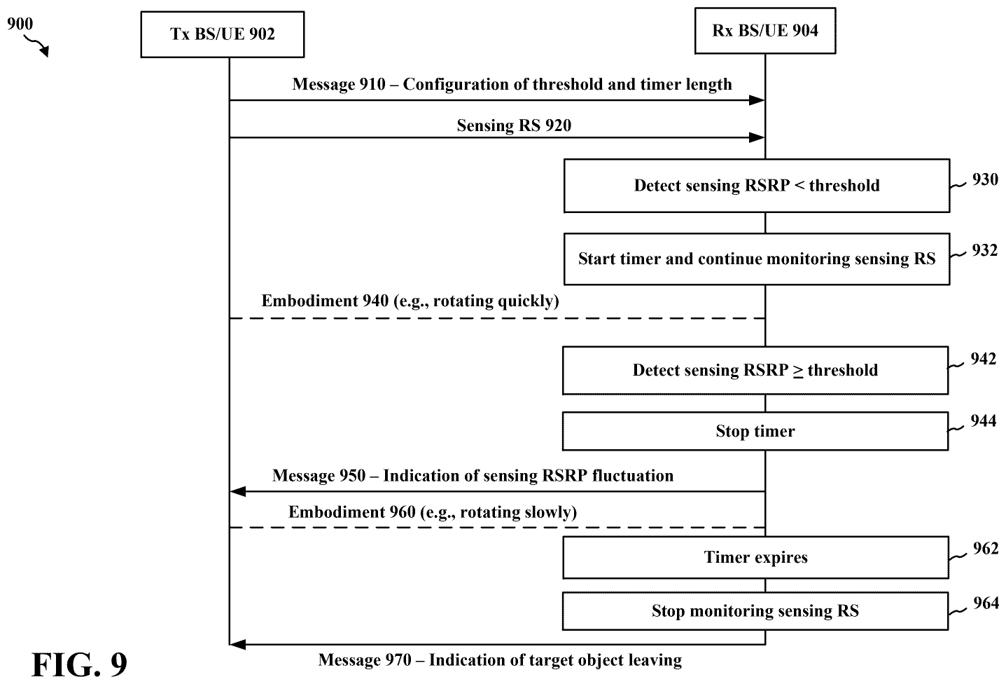

FIG. 9 illustrates diagram 900 including example communications in a wireless communication system. More specifically, diagram 900 in FIG. 9 shows example communications between a first wireless device (e.g., Tx BS/UE 902) and a second wireless device (e.g., Rx BS/UE 904). As shown in FIG. 9, Tx BS/UE 902 may transmit message 910 to Rx BS/UE 904, where message 910 may include a configuration of a threshold and a timer length of a timer associated with a sensing operation. Also, Tx BS/UE 902 may transmit sensing RS 920 to Rx BS/UE 904. At 930, Rx BS/UE 904 may detect whether (1) a sensing RSRP is less than a threshold or (2) at least one target object is outside of a monitoring area. If so, at 932, the Rx BS/UE 904 may start the timer and continue monitoring the sensing RS. In one embodiment (e.g., embodiment 940), the UAV may be rotating quickly. In this scenario, at 942, the Rx BS/UE 904 may detect whether at least one of: (1) the sensing RSRP is greater than or equal to the sensing threshold prior to an expiration of the timer length, or (2) the at least one target object is within a monitoring area prior to the expiration of the timer length. If so, at 944, the Rx BS/UE 904 may stop the timer. After this, the Rx BS/UE 904 may transmit message 950, which may include an indication of the sensing RSRP fluctuation or change. In another embodiment (e.g., embodiment 960), the UAV may be rotating slowly. In this scenario, at 962, the Rx BS/UE 904 may detect whether the sensing RSRP remains less than the sensing threshold until after an expiration of the timer length. If so, at 964, the Rx BS/UE 904 may stop monitoring the sensing RS. After this, the Rx BS/UE 904 may transmit message 970, which may include an indication of the target object leaving the monitoring area.

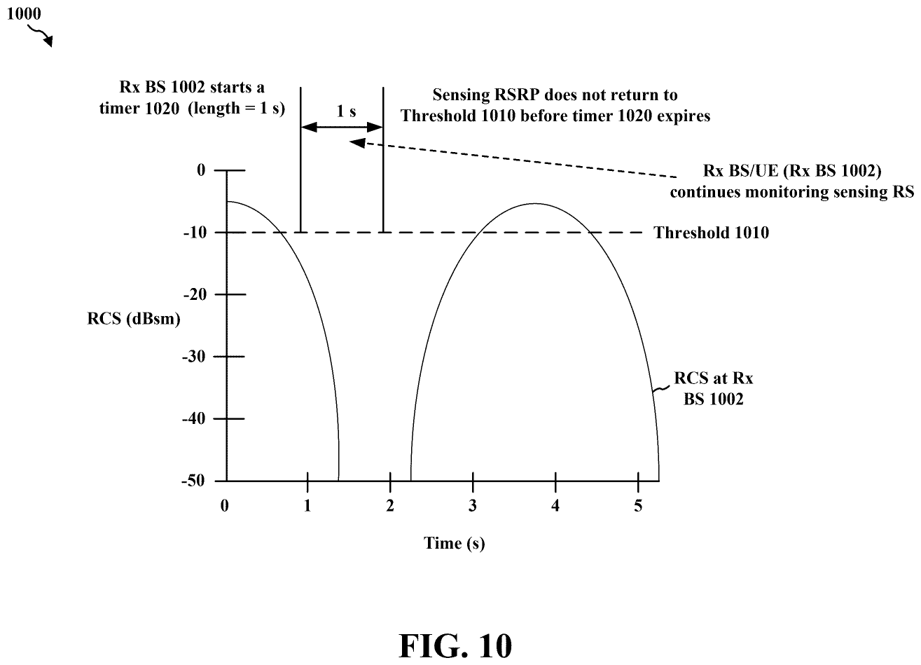

Aspects presented herein may also include a number of timer-base methods to account for RCS variance. FIG. 10 illustrates graph 1000 including an example timing for wireless communications. More specifically, graph 1000 in FIG. 10 shows an example timing for a sensing operation that compares RCS (in dBsm) vs. time (in seconds). As shown in FIG. 10, graph 1000 depicts that a Tx BS configures a sensing RSRP to equal threshold 1010, and Tx BS configures a timer length of timer 1020 to equal 1 second. Rx BS 1002 then starts the timer 1020 (with timer length=1 s). Graph 1000 charts the RCS at Rx BS 1002 in terms of RCS compared to time. As shown in FIG. 10, the sensing RSRP may not return to threshold 1010 before timer 1020 expires. Also, Rx BS/UE (e.g., Rx BS 1002) may continue monitoring the sensing RS. In the example shown in FIG. 10, the UAV may be rotating at a certain speed (e.g., 25 degrees per second).

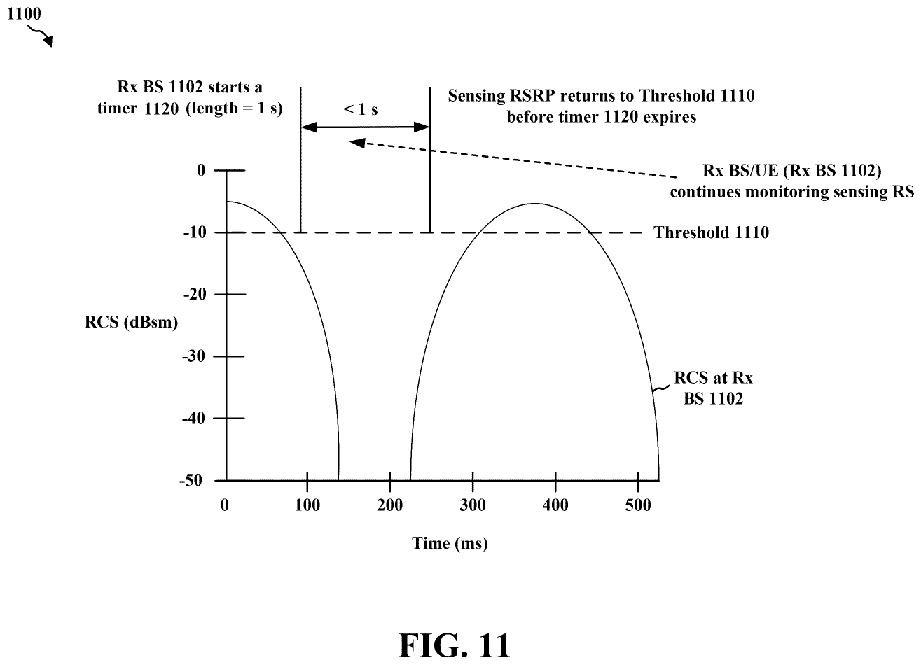

FIG. 11 illustrates graph 1100 including an example timing for wireless communications. More specifically, graph 1100 in FIG. 11 shows an example timing for a sensing operation that compares RCS (in dBsm) vs. time (in milliseconds). As shown in FIG. 11, graph 1100 depicts that a Tx BS configures a sensing RSRP to equal threshold 1110, and Tx BS configures a timer length of timer 1120 to equal 1 second. Rx BS 1102 then starts the timer 1120 (with timer length=1 s). Graph 1100 charts the RCS at Rx BS 1102 in terms of RCS compared to time. As shown in FIG. 11, the sensing RSRP may return to threshold 1110 before timer 1120 expires. Also, Rx BS/UE (e.g., Rx BS 1102) may continue monitoring the sensing RS. In the example shown in FIG. 11, the UAV may be rotating at a certain speed (e.g., 250 degrees per second).

The aforementioned timer-based method may have a number of benefits and other impacts. For instance, based on the timer-based method, a BS/UE may properly determine whether to continue monitoring or stop monitoring a sensing signal when the sensing RSRP becomes weak. This method may not just avoid radio resource waste, but also avoid long sensing latency caused by frequent radio resource applying/releasing (e.g., ping pong handover). In bi-static sensing, the Tx BS (or the sensing control node) may send a message to the Rx BS or Rx UE to configure a threshold (e.g., a threshold of G) and a timer length (e.g., a timer length of T). The Rx BS/UE may then send a message including an indication of a sensing RSRP fluctuation or change. This message may contain the sensing RSRP fluctuation amplitude and/or period. The Rx BS/UE may then send a message including an indication of a target object leaving a monitoring area.

Additionally, aspects presented herein may include a number of other methods to determine whether a UAV rotates or moves away (e.g., leaves a monitoring area). In one aspect, if the position information of a UAV is known to a Rx BS/UE, the Rx BS/UE may determine whether to continue to sense the UAV based on the position information. When the UAV has a communication function, the UAV may indicate its position information to the network. If the indicated position is still in the coverage of the network, even though the sensing RSRP is lower than the threshold, the Rx BS/UE may still monitor the sensing RS. Aspects presented herein may also utilize a micro-Doppler based UAV rotation and radial velocity determination. The BS/UE may determine the UAV rotation information and radial velocity based on a micro-Doppler measurement and/or analysis. If the UAV rotation is determined, even though the sensing RSRP is lower than the threshold, the Rx BS/UE may still monitor the sensing RS. In some aspects, a Doppler profile may include a mean Doppler shift, which depends on the linear speed projected in the direction of a reflective wave. Also, the Doppler spread may be at a maximum value when the reflective wave is perpendicular to the rotation angle.

For a UAV rotation determination, aspects presented herein may utilize a micro-Doppler analysis for a UAV rotation detection and radial velocity estimation. Aspects presented herein may determine a linear speed projected in the direction of reflective wave based on a mean Doppler shift. Also, aspects presented herein may determine UAV angles with respect to a reflected wave based on the micro-Doppler analysis. Therefore, a UAV rotation may be distinguished to reduce false handover. In multi-static sensing, in order to obtain an accurate positioning, multiple pairs of Tx and Rx may be utilized. For instance, a single receiver may not have complete Doppler information for a target object. Also, the linear speed may just be measured along a radial direction. Further, the rotation may not be detected if the rotation angle is along the reflected wave direction (i.e., the rotor blades are all perpendicular to the reflected wave). For example, multi-static sensing may allow a network to detect an evasive UAV that attempts to avoid detection by aligning its rotation with the reflected wave. In order to accurately detect the UAV rotation, aspects presented herein may utilize a second Tx-Rx pair. For instance, to improve the accuracy of UAV rotation detection, a BS/UE in monostatic sensing or bistatic sensing may request another BS/UE to perform the sensing and detect the UAV rotation/movement status.

Aspects of the present disclosure may include a number of benefits or advantages. For instance, aspects presented herein may reduce the amount of incorrect triggering of a sensing RS resource release due to RCS variance. In some instances, aspects presented herein may reduce the amount of certain types of handover (e.g., ping-pong handover) due to RCS variance. Aspects of the present disclosure may also allow the use of traditional communication handover methods when experiencing RCS variance. For instance, aspects of the present disclosure may optimize the ability to perform sensing operations with RCS variance. Further, aspects presented herein may provide efficient sensing operations for target objects including RCS variance.

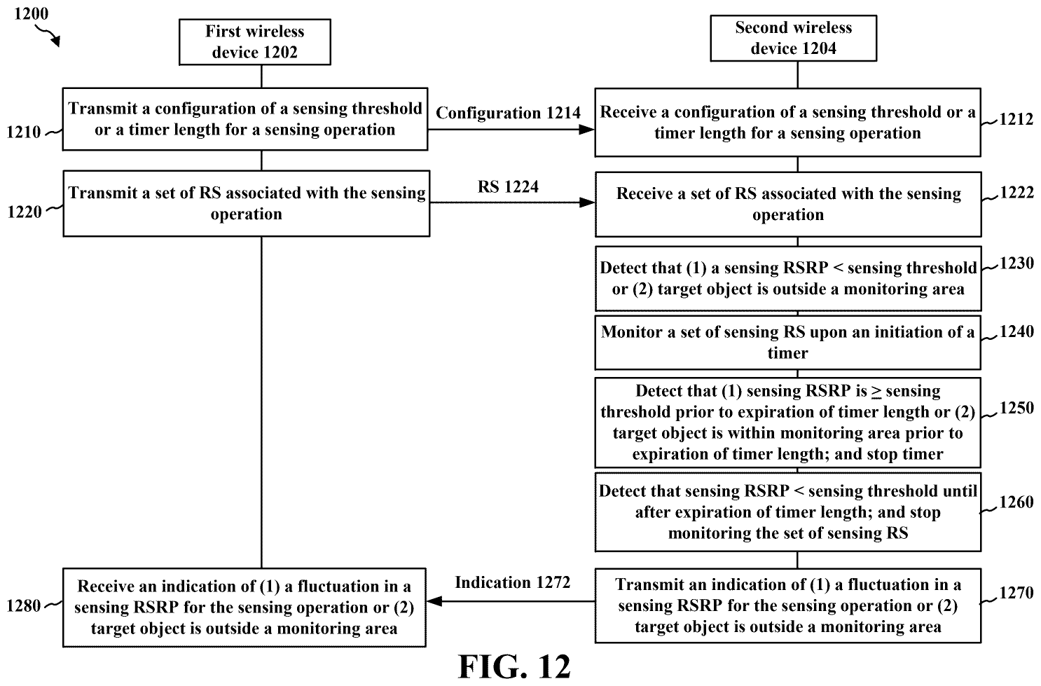

FIG. 12 is a communication flow diagram 1200 of wireless communication in accordance with one or more techniques of this disclosure. As shown in FIG. 12, diagram 1200 includes example communications between first wireless device 1202 (e.g., a base station or a UE) and second wireless device 1204 (e.g., a base station or a UE), in accordance with one or more techniques of this disclosure.

At 1210, first wireless device 1202 may transmit a configuration (e.g., configuration 1214) of at least one of a sensing threshold or a timer length for a timer associated with a sensing operation, where the configuration is transmitted to a second wireless device. The sensing operation may be at least one of a monostatic operation, a bistatic sensing operation, or a multi-static sensing operation.

At 1212, second wireless device 1204 may receive a configuration (e.g., configuration 1214) of at least one of a sensing threshold or a timer length for a timer associated with a sensing operation, where the configuration is received from a first wireless device. The sensing operation may be at least one of a monostatic operation, a bistatic sensing operation, or a multi-static sensing operation.

At 1220, first wireless device 1202 may transmit a set of reference signals (RS) (e.g., RS 1224) associated with the sensing operation, where the set of RS is transmitted for the second wireless device. The first wireless device may be a first user equipment (UE), a first base station, a first network node, or a first network entity, and the second wireless device may be a second UE, a second base station, a second network node, or a second network entity.

At 1222, second wireless device 1204 may receive a set of sensing RS (e.g., RS 1224) associated with the sensing operation prior to an initiation of a timer associated with the sensing operation, where the set of sensing RS is received from the first wireless device. The first wireless device may be a first user equipment (UE), a first base station, a first network node, or a first network entity, and the second wireless device may be a second UE, a second base station, a second network node, or a second network entity.

At 1230, second wireless device 1204 may detect that at least one of: (1) a sensing reference signal received power (RSRP) for the sensing operation is less than the sensing threshold, or (2) at least one target object is outside of a monitoring area.

At 1240, second wireless device 1204 may monitor a set of sensing reference signals (RS) upon an initiation of the timer associated with the sensing operation, where the timer is initiated for the timer length.

At 1250, second wireless device 1204 may detect that at least one of: (1) the sensing RSRP is greater than or equal to the sensing threshold prior to an expiration of the timer length, or (2) the at least one target object is within the monitoring area prior to the expiration of the timer length; and stop the timer. The timer may be stopped if the at least one target object is rotating at a rotation speed greater than a rotation threshold.

At 1260, second wireless device 1204 may detect that the sensing RSRP remains less than the sensing threshold until after an expiration of the timer length; and stop monitoring the set of sensing RS. The set of sensing RS may be stopped being monitored if the at least one target object is rotating at a rotation speed less than a rotation threshold.

At 1270, second wireless device 1204 may transmit an indication (e.g., indication 1272) of at least one of: (1) a fluctuation in the sensing RSRP for the sensing operation, or (2) the at least one target object is outside of the monitoring area, where the indication is transmitted to the first wireless device. The indication may include the fluctuation in the sensing RSRP for the sensing operation, where the indication may include at least one of an amplitude of the fluctuation in the sensing RSRP or a speed of the fluctuation in the sensing RSRP, or the indication may be associated with a rotation speed of the first wireless device. Also, the indication may include the at least one target object is outside of the monitoring area, and the set of sensing RS may no longer be transmitted to the second wireless device.

At 1280, first wireless device 1202 may receive an indication (e.g., indication 1272) of at least one of: (1) a fluctuation in a sensing reference signal received power (RSRP) for the sensing operation, or (2) at least one target object is outside of a monitoring area, where the indication is received from the second wireless device. In some instances, at least one of: (1) the sensing RSRP may be greater than or equal to the sensing threshold prior to an expiration of the timer length, or (2) the at least one target object may be within the monitoring area prior to the expiration of the timer length. Also, the timer may be stopped if the at least one target object is rotating at a rotation speed greater than a rotation threshold. The indication may include the fluctuation in the sensing RSRP for the sensing operation, where the indication includes at least one of an amplitude of the fluctuation in the sensing RSRP or a speed of the fluctuation in the sensing RSRP, or where the indication is associated with a rotation speed of the first wireless device. In some aspects, the sensing RSRP may remain less than the sensing threshold until after an expiration of the timer length. Also, the set of sensing RS may be stopped being monitored if the at least one target object is rotating at a rotation speed less than a rotation threshold. Further, the indication may include the at least one target object is outside of the monitoring area, and the set of sensing RS may no longer be transmitted to the second wireless device. In some aspects, the at least one target object may be detected to be outside of the monitoring area based on at least one of: (1) position information for the at least one target object, (2) rotation information for the at least one target object, or (3) a radial velocity of the at least one target object. The at least one target object may be detected to be outside of the monitoring area based on the position information for the at least one target object, and the at least one target object may include a communication function to indicate the position information for the at least one target object. The at least one target object may be detected to be outside of the monitoring area based on the rotation information for the at least one target object or the radial velocity of the at least one target object, and the rotation information or the radial velocity may be based on a micro-Doppler analysis. The micro-Doppler analysis may include a mean Doppler shift associated with a linear speed of the at least one target object corresponding to one or more reflected waves, or the micro-Doppler analysis may be based on one or more angles of the one or more reflected waves. Also, the micro-Doppler analysis may be associated with a pair of other wireless devices, such that the at least one target object may be detected to be outside of the monitoring area based on the pair of the other wireless devices.

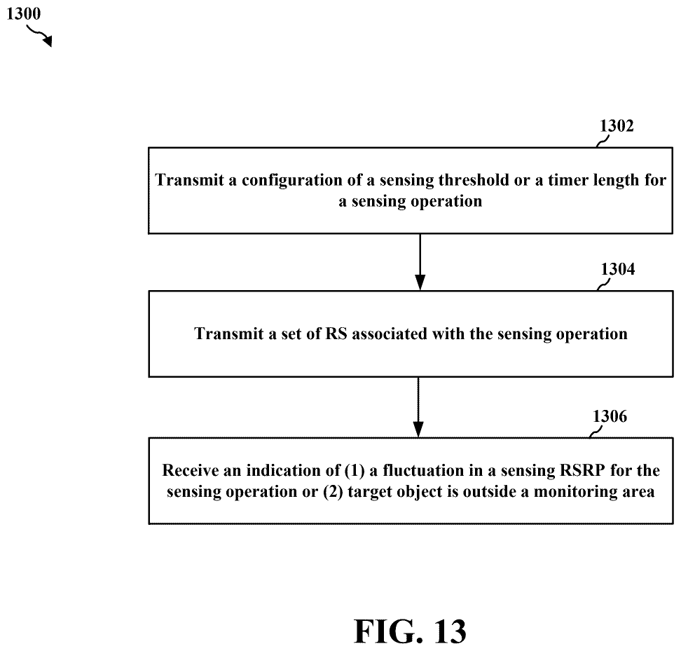

FIG. 13 is a flowchart 1300 of a method of wireless communication. The method may be performed by a first wireless device, such as a UE (e.g., the UE 104; Tx BS/UE 902, the apparatus 1704) or a base station (e.g., the base station 102; the network entity 1802). The methods described herein may provide a number of benefits, such as improving resource utilization and/or power savings.

At 1302, the first wireless device may transmit a configuration of at least one of a sensing threshold or a timer length for a timer associated with a sensing operation, where the configuration is transmitted to a second wireless device, as discussed with respect to FIGS. 4-12. For example, as described in 1210 of FIG. 12, the first wireless device 1202 may transmit a configuration of at least one of a sensing threshold or a timer length for a timer associated with a sensing operation, where the configuration is transmitted to a second wireless device. Further, step 1302 may be performed by sensing component 198. The sensing operation may be at least one of a monostatic operation, a bistatic sensing operation, or a multi-static sensing operation.

At 1304, the first wireless device may transmit a set of reference signals (RS) associated with the sensing operation, where the set of RS is transmitted for the second wireless device, as discussed with respect to FIGS. 4-12. For example, as described in 1220 of FIG. 12, the first wireless device 1202 may transmit a set of reference signals (RS) associated with the sensing operation, where the set of RS is transmitted for the second wireless device. Further, step 1304 may be performed by sensing component 198. The first wireless device may be a first user equipment (UE), a first base station, a first network node, or a first network entity, and the second wireless device may be a second UE, a second base station, a second network node, or a second network entity.

At 1306, the first wireless device may receive an indication of at least one of: (1) a fluctuation in a sensing reference signal received power (RSRP) for the sensing operation, or (2) at least one target object is outside of a monitoring area, where the indication is received from the second wireless device, as discussed with respect to FIGS. 4-12. For example, as described in 1280 of FIG. 12, the first wireless device 1202 may receive an indication of at least one of: (1) a fluctuation in a sensing reference signal received power (RSRP) for the sensing operation, or (2) at least one target object is outside of a monitoring area, where the indication is received from the second wireless device. Further, step 1306 may be performed by sensing component 198.

In some instances, (1) the sensing RSRP may be greater than or equal to the sensing threshold prior to an expiration of the timer length, and/or (2) the at least one target object may be within the monitoring area prior to the expiration of the timer length. Also, the timer may be stopped if the at least one target object is rotating at a rotation speed greater than a rotation threshold. The indication may include the fluctuation in the sensing RSRP for the sensing operation, where the indication includes at least one of an amplitude of the fluctuation in the sensing RSRP or a speed of the fluctuation in the sensing RSRP, or where the indication is associated with a rotation speed of the first wireless device. Also, in some instances, the sensing RSRP may remain less than the sensing threshold until after an expiration of the timer length. Also, the set of sensing RS may be stopped being monitored if the at least one target object is rotating at a rotation speed less than a rotation threshold. Further, the indication may include the at least one target object is outside of the monitoring area, and the set of sensing RS may no longer be transmitted to the second wireless device.

In some aspects, the at least one target object may be detected to be outside of the monitoring area based on at least one of: (1) position information for the at least one target object, (2) rotation information for the at least one target object, or (3) a radial velocity of the at least one target object. The at least one target object may be detected to be outside of the monitoring area based on the position information for the at least one target object, and the at least one target object may include a communication function to indicate the position information for the at least one target object. The at least one target object may be detected to be outside of the monitoring area based on the rotation information for the at least one target object or the radial velocity of the at least one target object, and the rotation information or the radial velocity may be based on a micro-Doppler analysis. The micro-Doppler analysis may include a mean Doppler shift associated with a linear speed of the at least one target object corresponding to one or more reflected waves, or the micro-Doppler analysis may be based on one or more angles of the one or more reflected waves. Also, the micro-Doppler analysis may be associated with a pair of other wireless devices, such that the at least one target object may be detected to be outside of the monitoring area based on the pair of the other wireless devices.

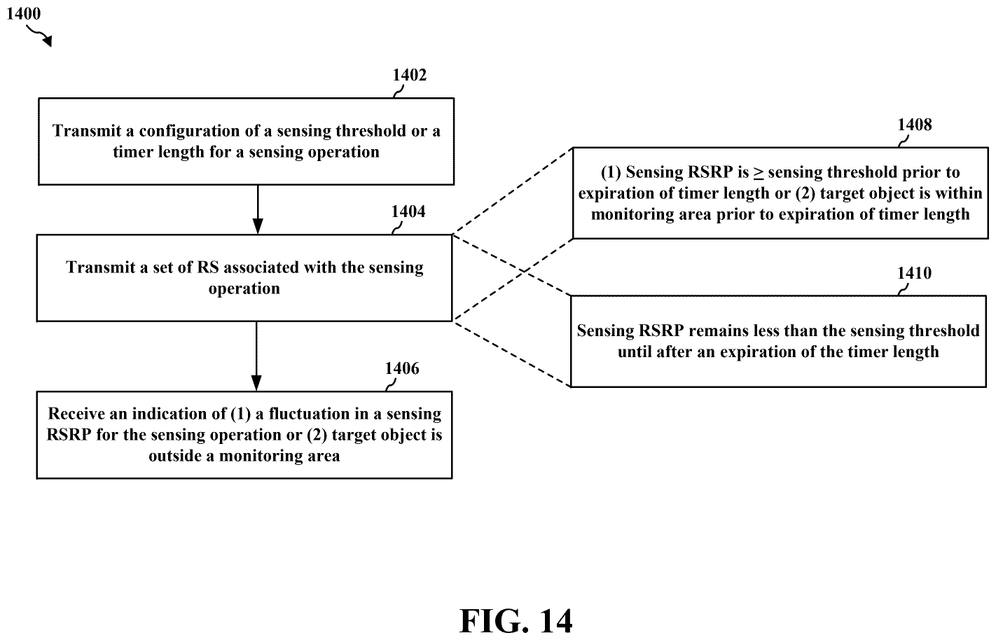

FIG. 14 is a flowchart 1400 of a method of wireless communication. The method may be performed by a first wireless device, such as a UE (e.g., the UE 104; Tx BS/UE 902, the apparatus 1704) or a base station (e.g., the base station 102; the network entity 1802). The methods described herein may provide a number of benefits, such as improving resource utilization and/or power savings.

At 1402, the first wireless device may transmit a configuration of at least one of a sensing threshold or a timer length for a timer associated with a sensing operation, where the configuration is transmitted to a second wireless device, as discussed with respect to FIGS. 4-12. For example, as described in 1210 of FIG. 12, the first wireless device 1202 may transmit a configuration of at least one of a sensing threshold or a timer length for a timer associated with a sensing operation, where the configuration is transmitted to a second wireless device. Further, step 1402 may be performed by sensing component 198. The sensing operation may be at least one of a monostatic operation, a bistatic sensing operation, or a multi-static sensing operation.

At 1404, the first wireless device may transmit a set of reference signals (RS) associated with the sensing operation, where the set of RS is transmitted for the second wireless device, as discussed with respect to FIGS. 4-12. For example, as described in 1220 of FIG. 12, the first wireless device 1202 may transmit a set of reference signals (RS) associated with the sensing operation, where the set of RS is transmitted for the second wireless device. Further, step 1404 may be performed by sensing component 198. The first wireless device may be a first user equipment (UE), a first base station, a first network node, or a first network entity, and the second wireless device may be a second UE, a second base station, a second network node, or a second network entity.

At 1406, the first wireless device may receive an indication of at least one of: (1) a fluctuation in a sensing reference signal received power (RSRP) for the sensing operation, or (2) at least one target object is outside of a monitoring area, where the indication is received from the second wireless device, as discussed with respect to FIGS. 4-12. For example, as described in 1280 of FIG. 12, the first wireless device 1202 may receive an indication of at least one of: (1) a fluctuation in a sensing reference signal received power (RSRP) for the sensing operation, or (2) at least one target object is outside of a monitoring area, where the indication is received from the second wireless device. Further, step 1406 may be performed by sensing component 198.

At 1408, (1) the sensing RSRP may be greater than or equal to the sensing threshold prior to an expiration of the timer length, and/or (2) the at least one target object may be within the monitoring area prior to the expiration of the timer length. Also, the timer may be stopped if the at least one target object is rotating at a rotation speed greater than a rotation threshold. The indication may include the fluctuation in the sensing RSRP for the sensing operation, where the indication includes at least one of an amplitude of the fluctuation in the sensing RSRP or a speed of the fluctuation in the sensing RSRP, or where the indication is associated with a rotation speed of the first wireless device.

At 1410, the sensing RSRP may remain less than the sensing threshold until after an expiration of the timer length. Also, the set of sensing RS may be stopped being monitored if the at least one target object is rotating at a rotation speed less than a rotation threshold. Further, the indication may include the at least one target object is outside of the monitoring area, and the set of sensing RS may no longer be transmitted to the second wireless device.

In some aspects, the at least one target object may be detected to be outside of the monitoring area based on at least one of: (1) position information for the at least one target object, (2) rotation information for the at least one target object, or (3) a radial velocity of the at least one target object. The at least one target object may be detected to be outside of the monitoring area based on the position information for the at least one target object, and the at least one target object may include a communication function to indicate the position information for the at least one target object. The at least one target object may be detected to be outside of the monitoring area based on the rotation information for the at least one target object or the radial velocity of the at least one target object, and the rotation information or the radial velocity may be based on a micro-Doppler analysis. The micro-Doppler analysis may include a mean Doppler shift associated with a linear speed of the at least one target object corresponding to one or more reflected waves, or the micro-Doppler analysis may be based on one or more angles of the one or more reflected waves. Also, the micro-Doppler analysis may be associated with a pair of other wireless devices, such that the at least one target object may be detected to be outside of the monitoring area based on the pair of the other wireless devices.

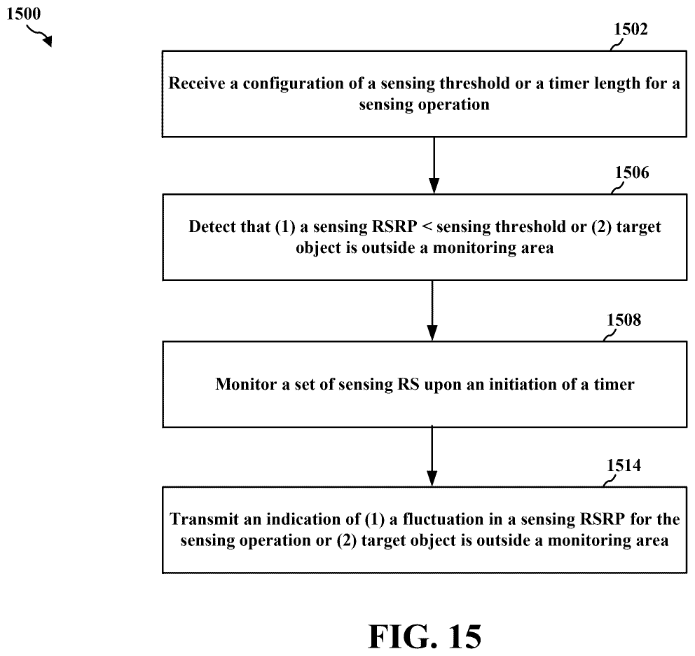

FIG. 15 is a flowchart 1500 of a method of wireless communication. The method may be performed by a second wireless device, such as a UE (e.g., the UE 104; Rx BS/UE 904, the apparatus 1704) or a base station (e.g., the base station 102; the network entity 1802). The methods described herein may provide a number of benefits, such as improving resource utilization and/or power savings.

At 1502, the second wireless device may receive a configuration of at least one of a sensing threshold or a timer length for a timer associated with a sensing operation, where the configuration is received from a first wireless device, as discussed with respect to FIGS. 4-12. For example, as described in 1212 of FIG. 12, the second wireless device 1204 may receive a configuration of at least one of a sensing threshold or a timer length for a timer associated with a sensing operation, where the configuration is received from a first wireless device. Further, step 1502 may be performed by sensing component 199. The sensing operation may be at least one of a monostatic operation, a bistatic sensing operation, or a multi-static sensing operation.

At 1506, the second wireless device may detect that at least one of: (1) a sensing reference signal received power (RSRP) for the sensing operation is less than the sensing threshold, or (2) at least one target object is outside of a monitoring area, as discussed with respect to FIGS. 4-12. For example, as described in 1230 of FIG. 12, the second wireless device 1204 may detect that at least one of: (1) a sensing reference signal received power (RSRP) for the sensing operation is less than the sensing threshold, or (2) at least one target object is outside of a monitoring area. Further, step 1506 may be performed by sensing component 199.

At 1508, the second wireless device may monitor a set of sensing reference signals (RS) upon an initiation of the timer associated with the sensing operation, where the timer is initiated for the timer length, as discussed with respect to FIGS. 4-12. For example, as described in 1240 of FIG. 12, the second wireless device 1204 may monitor a set of sensing reference signals (RS) upon an initiation of the timer associated with the sensing operation, where the timer is initiated for the timer length. Further, step 1508 may be performed by sensing component 199.

At 1514, the second wireless device may transmit an indication of at least one of: (1) a fluctuation in the sensing RSRP for the sensing operation, or (2) the at least one target object is outside of the monitoring area, where the indication is transmitted to the first wireless device, as discussed with respect to FIGS. 4-12. For example, as described in 1270 of FIG. 12, the second wireless device 1204 may transmit an indication of at least one of: (1) a fluctuation in the sensing RSRP for the sensing operation, or (2) the at least one target object is outside of the monitoring area, where the indication is transmitted to the first wireless device. Further, step 1514 may be performed by sensing component 199. The indication may include the fluctuation in the sensing RSRP for the sensing operation, where the indication may include at least one of an amplitude of the fluctuation in the sensing RSRP or a speed of the fluctuation in the sensing RSRP, or the indication may be associated with a rotation speed of the first wireless device. Also, the indication may include the at least one target object is outside of the monitoring area, and the set of sensing RS may no longer be transmitted to the second wireless device.

In some aspects, the at least one target object may be detected to be outside of the monitoring area based on at least one of: (1) position information for the at least one target object, (2) rotation information for the at least one target object, or (3) a radial velocity of the at least one target object. The at least one target object may be detected to be outside of the monitoring area based on the position information for the at least one target object, and the at least one target object may include a communication function to indicate the position information for the at least one target object. The at least one target object may be detected to be outside of the monitoring area based on the rotation information for the at least one target object or the radial velocity of the at least one target object, and the rotation information or the radial velocity may be based on a micro-Doppler analysis. The micro-Doppler analysis may include a mean Doppler shift associated with a linear speed of the at least one target object corresponding to one or more reflected waves, or the micro-Doppler analysis may be based on one or more angles of the one or more reflected waves. Also, the micro-Doppler analysis may be associated with a pair of other wireless devices, such that the at least one target object may be detected to be outside of the monitoring area based on the pair of the other wireless devices.

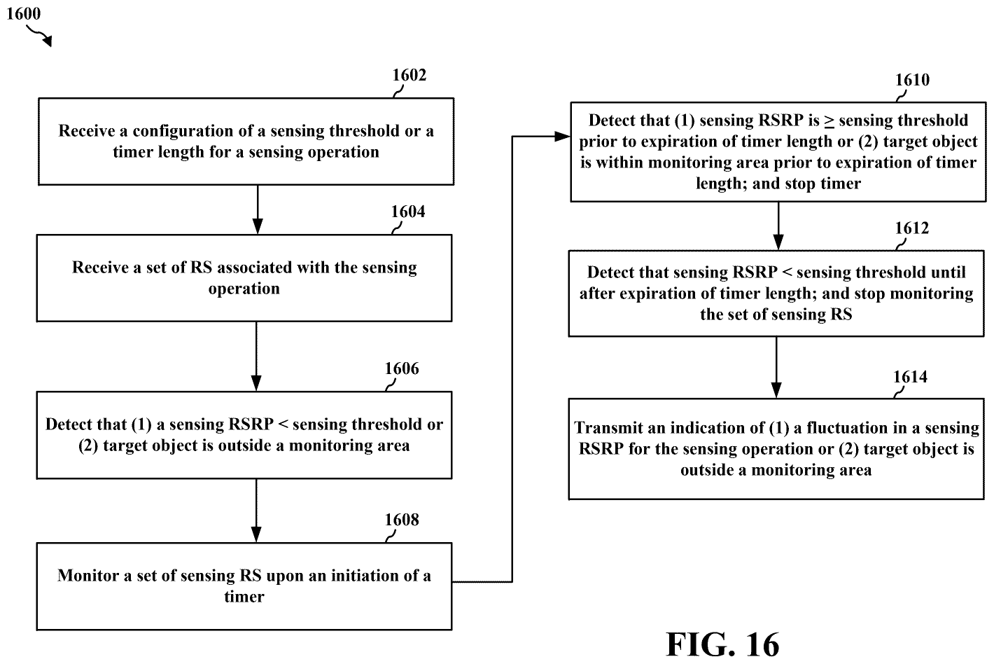

FIG. 16 is a flowchart 1600 of a method of wireless communication. The method may be performed by a second wireless device, such as a UE (e.g., the UE 104; Rx BS/UE 904, the apparatus 1704) or a base station (e.g., the base station 102; the network entity 1802). The methods described herein may provide a number of benefits, such as improving resource utilization and/or power savings.

At 1602, the second wireless device may receive a configuration of at least one of a sensing threshold or a timer length for a timer associated with a sensing operation, where the configuration is received from a first wireless device, as discussed with respect to FIGS. 4-12. For example, as described in 1212 of FIG. 12, the second wireless device 1204 may receive a configuration of at least one of a sensing threshold or a timer length for a timer associated with a sensing operation, where the configuration is received from a first wireless device. Further, step 1602 may be performed by sensing component 199. The sensing operation may be at least one of a monostatic operation, a bistatic sensing operation, or a multi-static sensing operation.

At 1604, the second wireless device may receive a set of sensing RS associated with the sensing operation prior to an initiation of a timer associated with the sensing operation, where the set of sensing RS is received from the first wireless device, as discussed with respect to FIGS. 4-12. For example, as described in 1222 of FIG. 12, the second wireless device 1204 may receive a set of sensing RS associated with the sensing operation prior to an initiation of a timer associated with the sensing operation, where the set of sensing RS is received from the first wireless device. Further, step 1604 may be performed by sensing component 199. The first wireless device may be a first user equipment (UE), a first base station, a first network node, or a first network entity, and the second wireless device may be a second UE, a second base station, a second network node, or a second network entity.

At 1606, the second wireless device may detect that at least one of: (1) a sensing reference signal received power (RSRP) for the sensing operation is less than the sensing threshold, or (2) at least one target object is outside of a monitoring area, as discussed with respect to FIGS. 4-12. For example, as described in 1230 of FIG. 12, the second wireless device 1204 may detect that at least one of: (1) a sensing reference signal received power (RSRP) for the sensing operation is less than the sensing threshold, or (2) at least one target object is outside of a monitoring area. Further, step 1606 may be performed by sensing component 199.

At 1608, the second wireless device may monitor a set of sensing reference signals (RS) upon an initiation of the timer associated with the sensing operation, where the timer is initiated for the timer length, as discussed with respect to FIGS. 4-12. For example, as described in 1240 of FIG. 12, the second wireless device 1204 may monitor a set of sensing reference signals (RS) upon an initiation of the timer associated with the sensing operation, where the timer is initiated for the timer length. Further, step 1608 may be performed by sensing component 199.

At 1610, the second wireless device may detect that at least one of: (1) the sensing RSRP is greater than or equal to the sensing threshold prior to an expiration of the timer length, or (2) the at least one target object is within the monitoring area prior to the expiration of the timer length; and stop the timer, as discussed with respect to FIGS. 4-12. For example, as described in 1250 of FIG. 12, the second wireless device 1204 may detect that at least one of: (1) the sensing RSRP is greater than or equal to the sensing threshold prior to an expiration of the timer length, or (2) the at least one target object is within the monitoring area prior to the expiration of the timer length; and stop the timer. Further, step 1610 may be performed by sensing component 199. The timer may be stopped if the at least one target object is rotating at a rotation speed greater than a rotation threshold.

At 1612, the second wireless device may detect that the sensing RSRP remains less than the sensing threshold until after an expiration of the timer length; and stop monitoring the set of sensing RS, as discussed with respect to FIGS. 4-12. For example, as described in 1260 of FIG. 12, the second wireless device 1204 may detect that the sensing RSRP remains less than the sensing threshold until after an expiration of the timer length; and stop monitoring the set of sensing RS. Further, step 1612 may be performed by sensing component 199. The set of sensing RS may be stopped being monitored if the at least one target object is rotating at a rotation speed less than a rotation threshold.

At 1614, the second wireless device may transmit an indication of at least one of: (1) a fluctuation in the sensing RSRP for the sensing operation, or (2) the at least one target object is outside of the monitoring area, where the indication is transmitted to the first wireless device, as discussed with respect to FIGS. 4-12. For example, as described in 1270 of FIG. 12, the second wireless device 1204 may transmit an indication of at least one of: (1) a fluctuation in the sensing RSRP for the sensing operation, or (2) the at least one target object is outside of the monitoring area, where the indication is transmitted to the first wireless device. Further, step 1614 may be performed by sensing component 199. The indication may include the fluctuation in the sensing RSRP for the sensing operation, where the indication may include at least one of an amplitude of the fluctuation in the sensing RSRP or a speed of the fluctuation in the sensing RSRP, or the indication may be associated with a rotation speed of the first wireless device. Also, the indication may include the at least one target object is outside of the monitoring area, and the set of sensing RS may no longer be transmitted to the second wireless device.

In some aspects, the at least one target object may be detected to be outside of the monitoring area based on at least one of: (1) position information for the at least one target object, (2) rotation information for the at least one target object, or (3) a radial velocity of the at least one target object. The at least one target object may be detected to be outside of the monitoring area based on the position information for the at least one target object, and the at least one target object may include a communication function to indicate the position information for the at least one target object. The at least one target object may be detected to be outside of the monitoring area based on the rotation information for the at least one target object or the radial velocity of the at least one target object, and the rotation information or the radial velocity may be based on a micro-Doppler analysis. The micro-Doppler analysis may include a mean Doppler shift associated with a linear speed of the at least one target object corresponding to one or more reflected waves, or the micro-Doppler analysis may be based on one or more angles of the one or more reflected waves. Also, the micro-Doppler analysis may be associated with a pair of other wireless devices, such that the at least one target object may be detected to be outside of the monitoring area based on the pair of the other wireless devices.

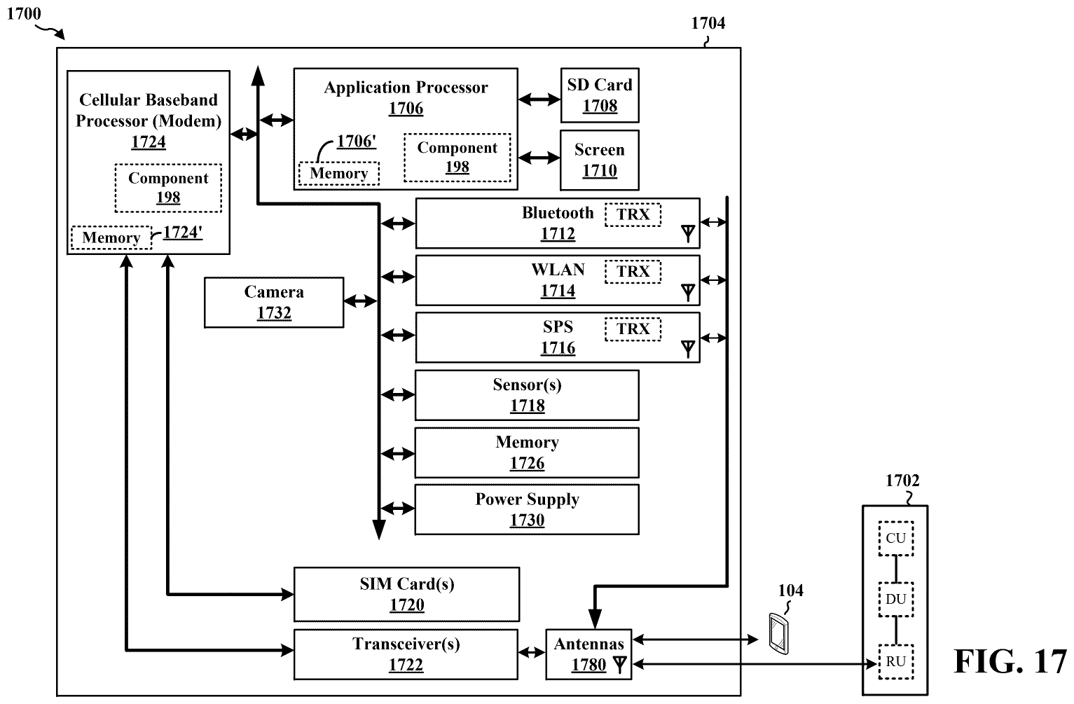

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra.

The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see 350 of FIG. 3) and include the additional modules of the apparatus 1704.

As discussed supra, the sensing component 198 may be configured to transmit a configuration of at least one of a sensing threshold or a timer length for a timer associated with a sensing operation, where the configuration is transmitted to a second wireless device. The sensing component 198 may also be configured to transmit a set of reference signals (RS) associated with the sensing operation, where the set of RS is transmitted for the second wireless device. The sensing component 198 may also be configured to receive an indication of at least one of: (1) a fluctuation in a sensing reference signal received power (RSRP) for the sensing operation, or (2) at least one target object is outside of a monitoring area, where the indication is received from the second wireless device.

The sensing component 198 may be within the cellular baseband processor 1724, the application processor 1706, or both the cellular baseband processor 1724 and the application processor 1706. The sensing component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, includes means for transmitting a configuration of at least one of a sensing threshold or a timer length for a timer associated with a sensing operation, where the configuration is transmitted to a second wireless device. The apparatus 1704 may also include means for transmitting a set of reference signals (RS) associated with the sensing operation, where the set of RS is transmitted for the second wireless device. The apparatus 1704 may also include means for receiving an indication of at least one of: (1) a fluctuation in a sensing reference signal received power (RSRP) for the sensing operation, or (2) at least one target object is outside of a monitoring area, where the indication is received from the second wireless device. The means may be the sensing component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

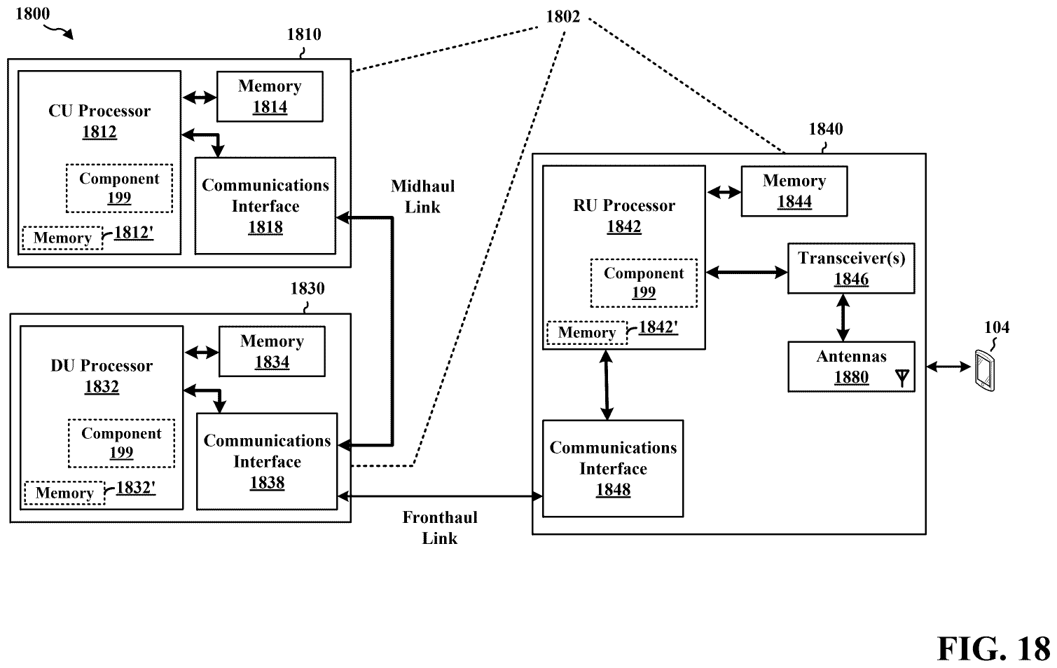

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the sensing component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software. As discussed supra, the sensing component 199 may be configured to receive a configuration of at least one of a sensing threshold or a timer length for a timer associated with a sensing operation, where the configuration is received from a first wireless device. The sensing component 199 may also be configured to detect that at least one of: (1) a sensing reference signal received power (RSRP) for the sensing operation is less than the sensing threshold, or (2) at least one target object is outside of a monitoring area. The sensing component 199 may also be configured to monitor a set of sensing reference signals (RS) upon an initiation of the timer associated with the sensing operation, where the timer is initiated for the timer length. The sensing component 199 may also be configured to transmit an indication of at least one of: (1) a fluctuation in the sensing RSRP for the sensing operation, or (2) the at least one target object is outside of the monitoring area, where the indication is transmitted to the first wireless device. The sensing component 199 may also be configured to detect that at least one of: (1) the sensing RSRP is greater than or equal to the sensing threshold prior to an expiration of the timer length, or (2) the at least one target object is within the monitoring area prior to the expiration of the timer length; and stop the timer. The sensing component 199 may also be configured to detect that the sensing RSRP remains less than the sensing threshold until after an expiration of the timer length; and stop monitoring the set of sensing RS. The sensing component 199 may also be configured to receive the set of sensing RS associated with the sensing operation prior to the initiation of the timer associated with the sensing operation, where the set of sensing RS is received from the first wireless device.

The sensing component 199 may be within one or more processors of one or more of the CU 1810, DU 1830, and the RU 1840. The sensing component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 includes means for receiving a configuration of at least one of a sensing threshold or a timer length for a timer associated with a sensing operation, where the configuration is received from a first wireless device. The network entity 1802 may also include means for detecting that at least one of: (1) a sensing reference signal received power (RSRP) for the sensing operation is less than the sensing threshold, or (2) at least one target object is outside of a monitoring area. The network entity 1802 may also include means for monitoring a set of sensing reference signals (RS) upon an initiation of the timer associated with the sensing operation, where the timer is initiated for the timer length. The network entity 1802 may also include means for transmitting an indication of at least one of: (1) a fluctuation in the sensing RSRP for the sensing operation, or (2) the at least one target object is outside of the monitoring area, where the indication is transmitted to the first wireless device. The network entity 1802 may also include means for detecting that at least one of: (1) the sensing RSRP is greater than or equal to the sensing threshold prior to an expiration of the timer length, or (2) the at least one target object is within the monitoring area prior to the expiration of the timer length; and means for stopping the timer. The network entity 1802 may also include means for detecting that the sensing RSRP remains less than the sensing threshold until after an expiration of the timer length; and means for stopping monitoring the set of sensing RS. The network entity 1802 may also include means for receiving the set of sensing RS associated with the sensing operation prior to the initiation of the timer associated with the sensing operation, where the set of sensing RS is received from the first wireless device. The means may be the sensing component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a first wireless device, including a memory and at least one processor coupled to the memory and, based at least in part on information stored in the memory, the at least one processor is configured to: transmit a configuration of at least one of a sensing threshold or a timer length for a timer associated with a sensing operation, where the configuration is transmitted to a second wireless device; transmit a set of reference signals (RS) associated with the sensing operation, where the set of RS is transmitted for the second wireless device; and receive an indication of at least one of: (1) a fluctuation in a sensing reference signal received power (RSRP) for the sensing operation, or (2) at least one target object is outside of a monitoring area, where the indication is received from the second wireless device.

Aspect 2 is the apparatus of aspect 1, where at least one of: (1) the sensing RSRP is greater than or equal to the sensing threshold prior to an expiration of the timer length, or (2) the at least one target object is within the monitoring area prior to the expiration of the timer length.

Aspect 3 is the apparatus of any of aspects 1 and 2, where the timer is stopped if the at least one target object is rotating at a rotation speed greater than a rotation threshold.

Aspect 4 is the apparatus of any of aspects 1 to 3, where the indication includes the fluctuation in the sensing RSRP for the sensing operation, where the indication includes at least one of an amplitude of the fluctuation in the sensing RSRP or a speed of the fluctuation in the sensing RSRP, or where the indication is associated with a rotation speed of the first wireless device.

Aspect 5 is the apparatus of any of aspects 1 to 4, where the sensing RSRP remains less than the sensing threshold until after an expiration of the timer length.

Aspect 6 is the apparatus of any of aspects 1 to 5, where the set of sensing RS is stopped being monitored if the at least one target object is rotating at a rotation speed less than a rotation threshold.

Aspect 7 is the apparatus of any of aspects 1 to 6, where the indication includes the at least one target object is outside of the monitoring area, and where the set of sensing RS is no longer transmitted to the second wireless device.

Aspect 8 is the apparatus of any of aspects 1 to 7, where the at least one target object is detected to be outside of the monitoring area based on at least one of: (1) position information for the at least one target object, (2) rotation information for the at least one target object, or (3) a radial velocity of the at least one target object.

Aspect 9 is the apparatus of any of aspects 1 to 8, where the at least one target object is detected to be outside of the monitoring area based on the position information for the at least one target object, and where the at least one target object includes a communication function to indicate the position information for the at least one target object.

Aspect 10 is the apparatus of any of aspects 1 to 9, where the at least one target object is detected to be outside of the monitoring area based on the rotation information for the at least one target object or the radial velocity of the at least one target object, and where the rotation information or the radial velocity is based on a micro-Doppler analysis.

Aspect 11 is the apparatus of any of aspects 1 to 10, where the micro-Doppler analysis includes a mean Doppler shift associated with a linear speed of the at least one target object corresponding to one or more reflected waves, or where the micro-Doppler analysis is based on one or more angles of the one or more reflected waves.

Aspect 12 is the apparatus of any of aspects 1 to 11, where the micro-Doppler analysis is associated with a pair of other wireless devices, such that the at least one target object is detected to be outside of the monitoring area based on the pair of the other wireless devices.

Aspect 13 is the apparatus of any of aspects 1 to 12, where the sensing operation is at least one of a monostatic operation, a bistatic sensing operation, or a multi-static sensing operation.

Aspect 14 is the apparatus of any of aspects 1 to 13, where the first wireless device is a first user equipment (UE), a first base station, a first network node, or a first network entity, and where the second wireless device is a second UE, a second base station, a second network node, or a second network entity.

Aspect 15 is an apparatus for wireless communication at a second wireless device, including a memory and at least one processor coupled to the memory and, based at least in part on information stored in the memory, the at least one processor is configured to: receive a configuration of at least one of a sensing threshold or a timer length for a timer associated with a sensing operation, where the configuration is received from a first wireless device; detect that at least one of: (1) a sensing reference signal received power (RSRP) for the sensing operation is less than the sensing threshold, or (2) at least one target object is outside of a monitoring area; monitor a set of sensing reference signals (RS) upon an initiation of the timer associated with the sensing operation, where the timer is initiated for the timer length; and transmit an indication of at least one of: (1) a fluctuation in the sensing RSRP for the sensing operation, or (2) the at least one target object is outside of the monitoring area, where the indication is transmitted to the first wireless device.

Aspect 16 is the apparatus of aspect 15, where the at least one processor is further configured to: detect that at least one of: (1) the sensing RSRP is greater than or equal to the sensing threshold prior to an expiration of the timer length, or (2) the at least one target object is within the monitoring area prior to the expiration of the timer length; and stop the timer.

Aspect 17 is the apparatus of any of aspects 15 and 16, where the timer is stopped if the at least one target object is rotating at a rotation speed greater than a rotation threshold.

Aspect 18 is the apparatus of any of aspects 15 to 17, where the indication includes the fluctuation in the sensing RSRP for the sensing operation, where the indication includes at least one of an amplitude of the fluctuation in the sensing RSRP or a speed of the fluctuation in the sensing RSRP, or where the indication is associated with a rotation speed of the first wireless device.

Aspect 19 is the apparatus of any of aspects 15 to 18, where the at least one processor is further configured to: detect that the sensing RSRP remains less than the sensing threshold until after an expiration of the timer length; and stop monitoring the set of sensing RS.

Aspect 20 is the apparatus of any of aspects 15 to 19, where the set of sensing RS is stopped being monitored if the at least one target object is rotating at a rotation speed less than a rotation threshold.

Aspect 21 is the apparatus of any of aspects 15 to 20, where the indication includes the at least one target object is outside of the monitoring area, and where the set of sensing RS is no longer transmitted to the second wireless device.

Aspect 22 is the apparatus of any of aspects 15 to 21, where the at least one processor is further configured to: receive the set of sensing RS associated with the sensing operation prior to the initiation of the timer associated with the sensing operation, where the set of sensing RS is received from the first wireless device.

Aspect 23 is the apparatus of any of aspects 15 to 22, where the at least one target object is detected to be outside of the monitoring area based on at least one of: (1) position information for the at least one target object, (2) rotation information for the at least one target object, or (3) a radial velocity of the at least one target object.

Aspect 24 is the apparatus of any of aspects 15 to 23, where the at least one target object is detected to be outside of the monitoring area based on the position information for the at least one target object, and where the at least one target object includes a communication function to indicate the position information for the at least one target object.

Aspect 25 is the apparatus of any of aspect 15 to 24, where the at least one target object is detected to be outside of the monitoring area based on the rotation information for the at least one target object or the radial velocity of the at least one target object, and where the rotation information or the radial velocity is based on a micro-Doppler analysis.

Aspect 26 is the apparatus of any of aspects 15 to 25, where the micro-Doppler analysis includes a mean Doppler shift associated with a linear speed of the at least one target object corresponding to one or more reflected waves, or where the micro-Doppler analysis is based on one or more angles of the one or more reflected waves.

Aspect 27 is the apparatus of any of aspects 15 to 26, where the micro-Doppler analysis is associated with a pair of other wireless devices, such that the at least one target object is detected to be outside of the monitoring area based on the pair of the other wireless devices.

Aspect 28 is the apparatus of any of aspects 15 to 27, where the sensing operation is at least one of a monostatic operation, a bistatic sensing operation, or a multi-static sensing operation, where the first wireless device is a first user equipment (UE), a first base station, a first network node, or a first network entity, and where the second wireless device is a second UE, a second base station, a second network node, or a second network entity.

Aspect 29 is the apparatus of any of aspects 1 to 28, where the apparatus is a wireless communication device, further including at least one of an antenna or a transceiver coupled to the at least one processor.

Aspect 30 is a method of wireless communication for implementing any of aspects 1 to 29.

Aspect 31 is an apparatus for wireless communication including means for implementing any of aspects 1 to 29.

Aspect 32 is a computer-readable medium (e.g., a non-transitory computer-readable medium) storing computer executable code, the code when executed by at least one processor causes the at least one processor to implement any of aspects 1 to 29.

What is claimed is:

1. An apparatus for wireless communication at a first wireless device, comprising:
a memory; and
at least one processor coupled to the memory and, based at least in part on information stored in the memory, the at least one processor is configured to:
transmit a configuration of at least one of a sensing threshold or a timer length for a timer associated with a sensing operation, wherein the configuration is transmitted to a second wireless device;
transmit a set of reference signals (RS) associated with the sensing operation, wherein the set of RS is transmitted for the second wireless device; and
receive an indication of at least one of: (1) a fluctuation in a sensing reference signal received power (RSRP) for the sensing operation, or (2) at least one target object is outside of a monitoring area, wherein the indication is received from the second wireless device.

2. The apparatus of claim 1, wherein at least one of: (1) the sensing RSRP is greater than or equal to the sensing threshold prior to an expiration of the timer length, or (2) the at least one target object is within the monitoring area prior to the expiration of the timer length.

3. The apparatus of claim 2, wherein the timer is stopped if the at least one target object is rotating at a rotation speed greater than a rotation threshold.

4. The apparatus of claim 2, wherein the indication includes the fluctuation in the sensing RSRP for the sensing operation, wherein the indication includes at least one of an amplitude of the fluctuation in the sensing RSRP or a speed of the fluctuation in the sensing RSRP, or wherein the indication is associated with a rotation speed of the first wireless device.

5. The apparatus of claim 1, wherein the sensing RSRP remains less than the sensing threshold until after an expiration of the timer length.

6. The apparatus of claim 5, wherein the set of sensing RS is stopped being monitored if the at least one target object is rotating at a rotation speed less than a rotation threshold.

7. The apparatus of claim 5, wherein the indication includes the at least one target object is outside of the monitoring area, and wherein the set of sensing RS is no longer transmitted to the second wireless device.

8. The apparatus of claim 1, wherein the at least one target object is detected to be outside of the monitoring area based on at least one of: (1) position information for the at least one target object, (2) rotation information for the at least one target object, or (3) a radial velocity of the at least one target object.

9. The apparatus of claim 8, wherein the at least one target object is detected to be outside of the monitoring area based on the position information for the at least one target object, and wherein the at least one target object includes a communication function to indicate the position information for the at least one target object.

10. The apparatus of claim 8, wherein the at least one target object is detected to be outside of the monitoring area based on the rotation information for the at least one target object or the radial velocity of the at least one target object, and wherein the rotation information or the radial velocity is based on a micro-Doppler analysis.

11. The apparatus of claim 10, wherein the micro-Doppler analysis includes a mean Doppler shift associated with a linear speed of the at least one target object corresponding to one or more reflected waves, or wherein the micro-Doppler analysis is based on one or more angles of the one or more reflected waves.

12. The apparatus of claim 10, wherein the micro-Doppler analysis is associated with a pair of other wireless devices, such that the at least one target object is detected to be outside of the monitoring area based on the pair of the other wireless devices.

13. The apparatus of claim 1, wherein the sensing operation is at least one of a monostatic operation, a bistatic sensing operation, or a multi-static sensing operation.

14. The apparatus of claim 1, wherein the first wireless device is a first user equipment (UE), a first base station, a first network node, or a first network entity, and wherein the second wireless device is a second UE, a second base station, a second network node, or a second network entity.

15. An apparatus for wireless communication at a second wireless device, comprising:
a memory; and
at least one processor coupled to the memory and, based at least in part on information stored in the memory, the at least one processor is configured to:
receive a configuration of at least one of a sensing threshold or a timer length for a timer associated with a sensing operation, wherein the configuration is received from a first wireless device;
detect that at least one of: (1) a sensing reference signal received power (RSRP) for the sensing operation is less than the sensing threshold, or (2) at least one target object is outside of a monitoring area;
monitor a set of sensing reference signals (RS) upon an initiation of the timer associated with the sensing operation, wherein the timer is initiated for the timer length; and
transmit an indication of at least one of: (1) a fluctuation in the sensing RSRP for the sensing operation, or (2) the at least one target object is outside of the monitoring area, wherein the indication is transmitted to the first wireless device.

16. The apparatus of claim 15, wherein the at least one processor is further configured to:
detect that at least one of: (1) the sensing RSRP is greater than or equal to the sensing threshold prior to an expiration of the timer length, or (2) the at least one target object is within the monitoring area prior to the expiration of the timer length; and
stop the timer.

17. The apparatus of claim 16, wherein the timer is stopped if the at least one target object is rotating at a rotation speed greater than a rotation threshold.

18. The apparatus of claim 16, wherein the indication includes the fluctuation in the sensing RSRP for the sensing operation, wherein the indication includes at least one of an amplitude of the fluctuation in the sensing RSRP or a speed of the fluctuation in the sensing RSRP, or wherein the indication is associated with a rotation speed of the first wireless device.

19. The apparatus of claim 15, wherein the at least one processor is further configured to:
detect that the sensing RSRP remains less than the sensing threshold until after an expiration of the timer length; and
stop monitoring the set of sensing RS.

20. The apparatus of claim 19, wherein the set of sensing RS is stopped being monitored if the at least one target object is rotating at a rotation speed less than a rotation threshold.

21. The apparatus of claim 19, wherein the indication includes the at least one target object is outside of the monitoring area, and wherein the set of sensing RS is no longer transmitted to the second wireless device.

22. The apparatus of claim 15, wherein the at least one processor is further configured to:
receive the set of sensing RS associated with the sensing operation prior to the initiation of the timer associated with the sensing operation, wherein the set of sensing RS is received from the first wireless device.

23. The apparatus of claim 15, wherein the at least one target object is detected to be outside of the monitoring area based on at least one of: (1) position information for the at least one target object, (2) rotation information for the at least one target object, or (3) a radial velocity of the at least one target object.

24. The apparatus of claim 23, wherein the at least one target object is detected to be outside of the monitoring area based on the position information for the at least one target object, and wherein the at least one target object includes a communication function to indicate the position information for the at least one target object.

25. The apparatus of claim 23, wherein the at least one target object is detected to be outside of the monitoring area based on the rotation information for the at least one target object or the radial velocity of the at least one target object, and wherein the rotation information or the radial velocity is based on a micro-Doppler analysis.

26. The apparatus of claim 25, wherein the micro-Doppler analysis includes a mean Doppler shift associated with a linear speed of the at least one target object corresponding to one or more reflected waves, or wherein the micro-Doppler analysis is based on one or more angles of the one or more reflected waves.

27. The apparatus of claim 25, wherein the micro-Doppler analysis is associated with a pair of other wireless devices, such that the at least one target object is detected to be outside of the monitoring area based on the pair of the other wireless devices.

28. The apparatus of claim 15, wherein the sensing operation is at least one of a monostatic operation, a bistatic sensing operation, or a multi-static sensing operation, wherein the first wireless device is a first user equipment (UE), a first base station, a first network node, or a first network entity, and wherein the second wireless device is a second UE, a second base station, a second network node, or a second network entity.

29. A method of wireless communication at a first wireless device, comprising:
transmitting a configuration of at least one of a sensing threshold or a timer length for a timer associated with a sensing operation, wherein the configuration is transmitted to a second wireless device;
transmitting a set of reference signals (RS) associated with the sensing operation, wherein the set of RS is transmitted for the second wireless device; and
receiving an indication of at least one of: (1) a fluctuation in a sensing reference signal received power (RSRP) for the sensing operation, or (2) at least one target object is outside of a monitoring area, wherein the indication is received from the second wireless device.

30. A method of wireless communication at a second wireless device, comprising:
receiving a configuration of at least one of a sensing threshold or a timer length for a timer associated with a sensing operation, wherein the configuration is received from a first wireless device;
detecting that at least one of: (1) a sensing reference signal received power (RSRP) for the sensing operation is less than the sensing threshold, or (2) at least one target object is outside of a monitoring area;
monitoring a set of sensing reference signals (RS) upon an initiation of the timer associated with the sensing operation, wherein the timer is initiated for the timer length; and
transmitting an indication of at least one of: (1) a fluctuation in the sensing RSRP for the sensing operation, or (2) the at least one target object is outside of the monitoring area, wherein the indication is transmitted to the first wireless device.
